(19) United States
(12) Patent Application Publication
(10) Pub. No.: US 2019/0381719 A1
(43) Pub. Date: Dec. 19, 2019

(54) MANUFACTURING SYSTEMS FOR THIN FILMS, AND ASSOCIATED METHODS

(71) Applicant: GlassPoint Solar, Inc., Fremont, CA (US)

(72) Inventors: Peter Emery von Behrens, Oakland, CA (US); Dylan Miller Fairbanks, Alameda, CA (US); Cynthia M. Wight, Fremont, CA (US)

(21) Appl. No.: 16/261,358

(22) Filed: Jan. 29, 2019

Related U.S. Application Data
(60) Provisional application No. 62/624,702, filed on Jan. 31, 2018.

(51) Int. Cl. B29C 55/02; B29C 71/02

(52) U.S. Cl. CPC B29C 55/023; B29C 51/42; B29C 71/02

(57) ABSTRACT

Manufacturing systems and methods for thin films, including modifying thin film into engineered film panels, are provided. Some embodiments of the present technology are directed to applying an edging material to a film edge of a thin film in an automated and continuous manner, and some embodiments are directed to treating thin films by adjusting one or more dimensions of the thin film using an adjustable structure, and heating the adjusted portion of the thin film, in addition to, or in lieu of applying the edging material.

### CROSS-REFERENCE TO RELATED APPLICATION

The present application claims priority to pending U.S. Provisional Application No. 62/624,702, filed on Jan. 31, 2018, and incorporated herein by reference in its entirety.

### TECHNICAL FIELD

The present technology is directed generally to manufacturing systems for thin films, or more particularly, to modifying thin films into engineered film panels. Some embodiments include improvements to thin film production and processing techniques for manufacturing thin films used for solar collection enclosures.

### BACKGROUND

Thin films are used to form enclosures that can have a controlled atmosphere, or shield internal areas of the enclosure from general weather conditions (e.g., rain, wind, dust, particulates, etc.). Typical applications for these enclosures can include greenhouses. While thin films have proven useful in these contexts, the use and/or installation of thin films presents a variety of manufacturing and handling issues. Accordingly, there remains a need in the art for improved manufacturing and handling techniques associated with thin film enclosures.

### BRIEF DESCRIPTION OF THE DRAWINGS

FIG. 1A is a partially schematic illustration of a thin film enclosure used for solar energy collection, in accordance with some embodiments of the present technology.

FIG. 1B is a partially schematic isometric view of a system configured to apply a material to edge portions of a thin film, in accordance with some embodiments of the present technology.

FIGS. 2A-2C are partially schematic views of a supply device used in the system shown in FIG. 1B.

FIGS. 3A and 3B are partially schematic isometric views of a drive device used in the system shown in FIG. 1B.

FIG. 4 is a partially schematic isometric view of an adhesive application device used in the system shown in FIG. 1B.

FIG. 5 is a partially schematic side view of a system configured to apply a material to edge portions of a thin film, in accordance with some embodiments of the present technology.

FIGS. 6A and 6B are partially schematic isometric views of a system configured to treat a thin film, in accordance with some embodiments of the present technology.

FIG. 7 is a partially schematic isometric view of a corner mechanism of the system shown in FIG. 6B.

FIG. 8 is a partially schematic view of a system configured to treat a thin film, in accordance with some embodiments of the present technology.

FIG. 9 is a block diagram of a thermal system, in accordance with some embodiments of the present technology.

FIG. 10 is a partially schematic plan view of portions of the thermal system represented in FIG. 9.

FIG. 11 is a partially schematic top view of portions of a system configured to apply a material to edge portions of a thin film, in accordance with some embodiments of the present technology.

FIG. 12 is a partially schematic top view of a treated thin film, in accordance with some embodiments of the present technology.

FIG. 13A and 13B are partially schematic views of a system configured to treat a thin film, in accordance with some embodiments of the present technology.

FIGS. 14A-14D are partially schematic views of another system configured to treat a thin film, in accordance with some embodiments of the present technology.

### DETAILED DESCRIPTION

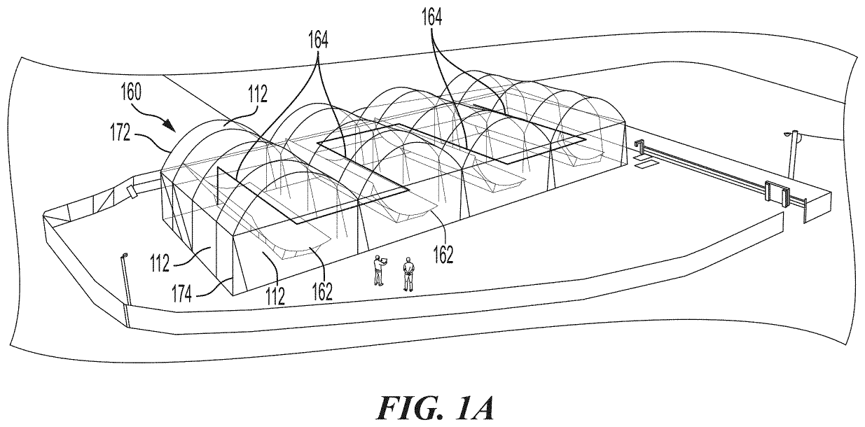

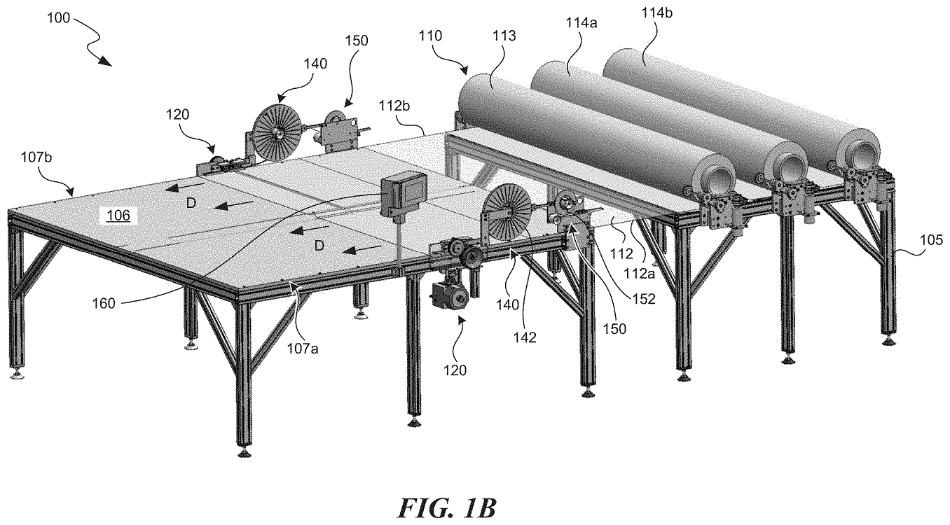

The present technology is generally directed to thin film engineered panels used in solar energy collection and/or other applications. Such other applications can include agriculture, stadiums, outdoor venues, and/or other settings where a controlled environment and/or an environment at least partially shielded from the effects of weather are desired. An aspect of the present technology, as described in FIGS. 1B-5 and 11, can be used to improve the manufacturing systems and methods associated with reinforcing the edges of a thin film by applying an edging material to a film edge in an automated and continuous manner. For example, the technology can include a supply device that provides a continuous supply of film. The film can be pulled by a drive device, including a motor and a drive wheel, that control the speed at which the film is pulled. A material application device can apply an edging material to edge portions of the film as the film is being pulled by the drive device. Additionally, an adhesive application device can apply an adhesive material to the edging material to bond the thin film to the edging material. In some embodiments, an edge sensor can detect an edge of the thin film, and adjust components (e.g., the material application device and/or adhesive application device) to ensure they are aligned with the edge as the film is pulled. A benefit of this technology is the time and cost saved by automating the material application process, and eliminating the amount of human error typically associated with conventional manufacturing techniques. Additionally, embodiments of the present technology can be used to make film installation into corresponding end structures (a) simpler, because the thin films can be installed while in a relaxed position (e.g., with slack), and (b) more reproducible because each panel is a precision engineered panel from a factory, and does not need to be hand stretched in the field. As a result of these benefits, the risk of premature failure is reduced and performance is optimized.

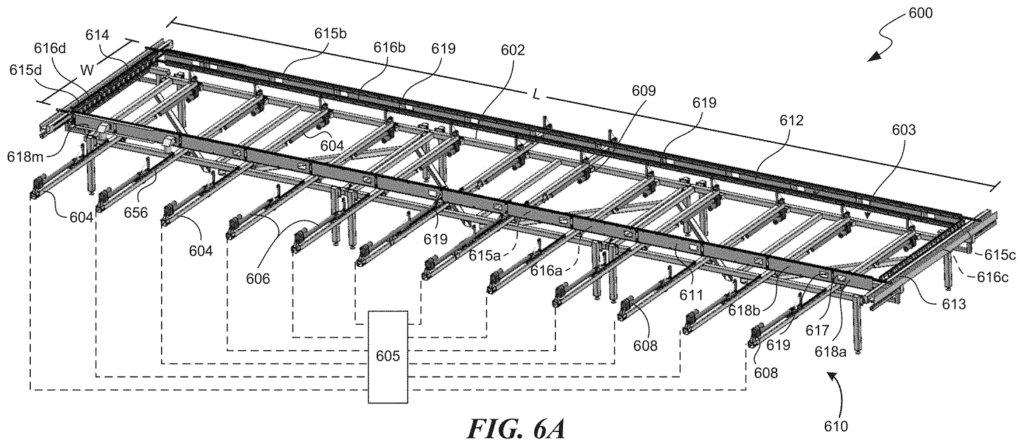

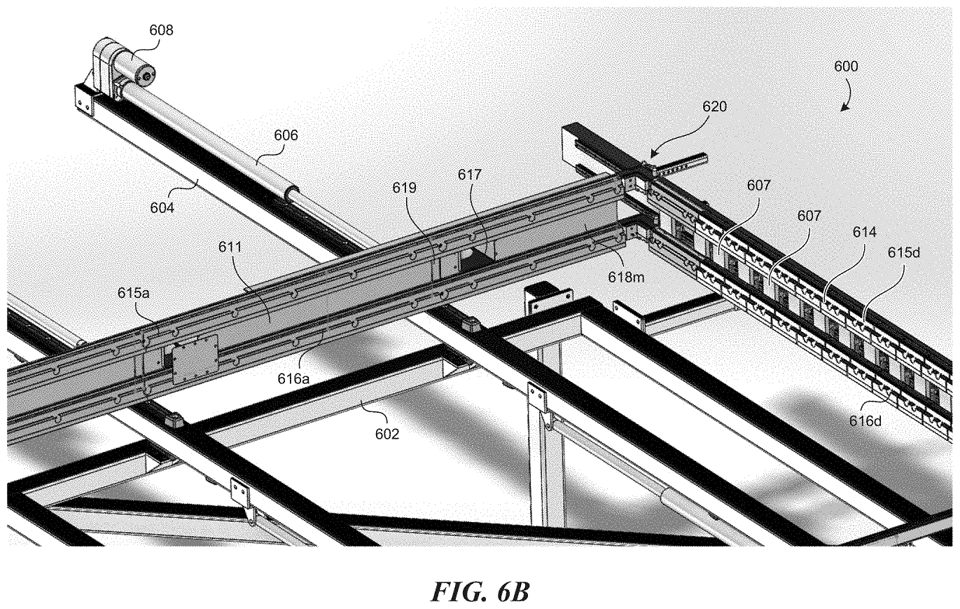

Another aspect of the present technology, as described in FIGS. 6-10 and 12-14, is the ability to treat thin films to have target characteristics. For example, some embodiments of the present technology include adjusting one or more dimensions of a thin film using an adjustable structure. In some embodiments, the thin film is secured to the adjustable structure, and one or more rails of the adjustable structure are moved such that the film is stretched from a first width to a second width larger than the first width. Heat can be applied to the film to lock in characteristics of the stretched film. A benefit of this technology is the ability to treat and form a thin film with a desired shape and in an efficient manner.

Certain aspects of the technology described in the context of some embodiments may be combined with other aspects described with reference to other embodiments. For example, the aspects described with reference to FIGS. 1B-5 and 11 can be combined with the aspects described with reference to FIGS. 6-10 and 12-14D. In some embodiments, the aspects described in these Figures may be combined in an end-to-end manufacturing system, e.g., with the process for applying edging material to a film edge of a thin film occurring upstream of the process for treating (e.g., stretching, heating, and/or relaxing) the thin film.

### Applying Material to Edge Portions of Thin Films

FIG. 1A is a partially schematic isometric illustration of an enclosure 160 housing solar concentrators 162 and receivers (e.g., conduits) 164. In some embodiments, the enclosure 160 includes a support structure, including curved support members 172 supported by uprights 174, which together support the thin film 112 in a tensioned arrangement to protect the interior of the enclosure 160. Inside the enclosure 160, the multiple concentrators 162 direct sunlight to corresponding receivers 164 to heat and convert water passing through the receivers 164 to steam. The steam can be used for power generation, solar enhanced oil recovery (EOR) operations, and/or other industrial processes.

To form the enclosures 160, edges of the thin films 112 are inserted into end connecting portions of fixed structures, e.g., the support members 172 and/or the uprights 174, that can maintain the thin films 112 in a taut or relaxed position, depending on the desired application. An issue encountered with forming the enclosures 160 is the difficulty of inserting the edges of the thin films 112 into the end connecting portions. This is in part because the edges of thin films 112 can be partially flexible and thus difficult to handle for an entire length of the thin film 112. One approach to dealing with this issue is to apply an edge material to the edges of the thin films, which can stiffen and provide rigidity to the edges, and make them easier to handle and insert into the connecting portions of the fixed structures. A follow-on problem, though, with this approach is the difficulty associated with applying the edge material to the edges. For example, applying edge materials to the thin films 112 can require significant time and labor costs, and can be inconsistent due to typical human error. Additionally, application of the edge materials onto the thin films 112 can lack precision. Accordingly, there remains a need for more effective systems and methods for the application of edge materials onto thin films 112.

Another issue associated with thin films 112 is the limited availability of thin films 112 in large dimensions (e.g., large widths) for industrial applications (e.g., solar EOR operations and greenhouses). The thin films 112 typically come in standard roll widths (e.g., panel sizes), and ordering larger roll widths or joining individual rolls (e.g., panels) together to form larger rolls can be cost-prohibitive. For example, joining rolls together can require significant time and labor costs, thereby making some projects that benefit from larger rolls economically unfeasible. Similar problems exist when panels having distinct, irregular shapes are needed. Additionally, conventional methods of joining or seaming rolls or panels together often involve heat welding roll materials together, which can be difficult and expensive to do on a large scale, or puncturing the roll material, which can thereby weaken the roll and thus the end product. Accordingly, there remains a need to treat thin films to form a target roll width while still maintaining adequate strength of the thin film material itself.

FIG. 1B is a partially schematic isometric view of an automated system 100 (“system 100”) for applying an edging material to edge portions of a thin film. The system 100 includes a support structure 105 having a surface 106 and a supply device 110 positioned proximate to (e.g., adjacent to and over) the support structure 105. The surface 106 can be selected to be made of a material (e.g., a metal or other conductive material) that dissipates static charge buildups, so that the thin film does not stick or pick up dust. In some embodiments, the surface 106 is omitted. The supply device 110 can include an active film spool 113, and one or more queued film spools 114a, 114b (collectively “queued film spools 114”) to be used as backup spools once the thin film 112 for the active film spool 113 has been dispensed. Each of the film spools 113, 114 includes a thin film 112, which can include ethylene tetrafluoroethylene (ETFE), fluorinated ethylene propylene (FEP), polytetrafluoroethylene (PTFE), polyethylene (PE), polyethylene terephthalate (PET), another suitable polymer, or any suitable combination thereof. In addition to or in lieu of the foregoing, the thin film 112 can be non-uniform, welded, reinforced, or pre-conditioned (e.g., with a film stretch built in or an adhesive). As an example, the thin film 112 can include Mylar™ or Teflon™. In some embodiments, the thin film 112 can be composed of polycarbonate, and can include adhesive elements. As shown in FIG. 1B, the thin film 112 is pulled from the supply device 110, and includes a first edge portion 112a toward a first end 107a of the support structure 105 and a second edge portion 112b toward a second end 107b of the support structure 105.

The system 100 can further comprise a drive device 120 configured to pull the thin film 112 from the supply device 110, a material application device 140 configured to apply an edging material 142 (e.g. a stiffener) to the edge portions 112a, 112b of the thin film 112, and an adhesive application device 150 configured to apply an adhesive material 152 to the edge portions 112a, 112b of the thin film 112 or to the edging material 142. The thin film 112 is pulled in a direction away from the supply device 110, as shown by the arrows (D). The edging material 142 and adhesive material 152 can initially be manually applied to the thin film 112. Once the edging material 142 and adhesive material 152 are initially applied to the thin film 112, pulling the thin film 112 can then cause additional edging material 142 and adhesive material 152 to be applied to the thin film 112 in a continuous manner. Each of the drive device 120, the material application device 140, and the adhesive application device 150 can be positioned at one or both ends 107a, 107b of the surface 106, thereby allowing the edging material 142 and adhesive material 152 to be applied to the first and second edge portions 112a, 112b of the thin film 112 simultaneously. In such an embodiment, the drive devices 120 at each end 107a, 107b of the surface 106 can be mechanically coupled to one another via a drive shaft extending between the drive devices 120. In some embodiments, the thin film 112 may be preconditioned with an adhesive or the edging material 142 can include an adhesive, thereby allowing the adhesive application device 150 to be omitted from the system 100.

The system 100 can further comprise a controller 160 in communication with at least the drive device 120 and the supply device 110. The controller 160 can control the production rate of the system 100 by determining the rate at which the thin film 112 is pulled by the drive device 120. For example, the controller 160 can adjust the speed of a motor associated with the drive device 120 based on received inputs from the supply device 110. The controller 160 can issue computer-executable instructions, including routines executed by a programmable computer. The controller 160 may, for example, also include a combination of supervisory control and data acquisition (SCADA) systems, distributed control systems (DCS), programmable logic controllers (PLC), control devices, and processors configured to process computer-executable instructions. Those skilled in the relevant art will appreciate that the technology can be practiced on computer systems, or in a data processor that is specifically programmed, configured or constructed to perform one or more of the computer-executable instructions described below. Accordingly, the terms “controller” as generally used herein refer to any mechanical, electrical or electro-mechanical device, including but not limited to a data processor.

The present technology includes a number of benefits related to manufacturing thin film panels. For example, the application of the edging material to the thin film in a continuous manner allows the thin film panels to be manufactured more quickly, thereby decreasing overall costs associated with the manufacturing of the thin films. Additionally, the edging material is applied to the thin film in an automated and precise manner, thereby reducing the likelihood of human error and imperfections common in more manual manufacturing methods. The precise and consistent application of the edging material to the edge portions of the thin film helps ensure that when the edging material is installed in its end structure or application, tension is distributed evenly across the edge portions of the thin film.

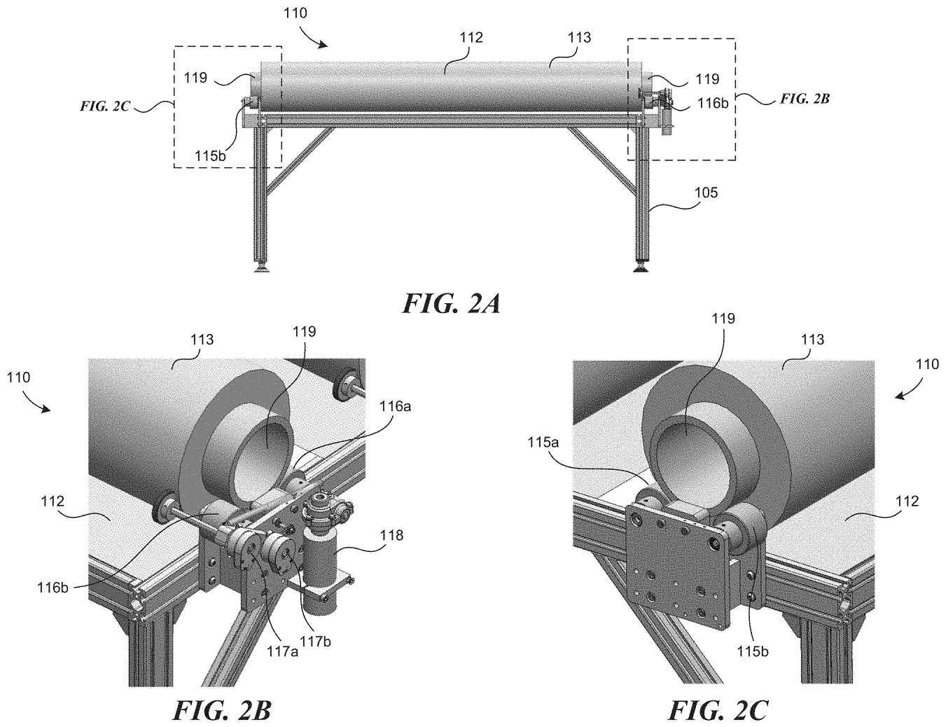

FIGS. 2A-2C are partially schematic views of a representative supply device 110, as also shown in FIG. 1B. Specifically, FIG. 2A illustrates an end view of the supply device 110 on the support structure 105, and FIGS. 2B and 2C illustrate opposite ends of the supply device 110. As shown in FIG. 2A, the active film spool 113 includes an inner member 119 and the thin film 112 that is wrapped around the inner member 119. The inner member 119 protrudes outwardly from the thin film 112 at each end of the active film spool 113. As shown in FIG. 2B, the supply device 110 includes a set of active rollers 116a, 116b (collectively “active rollers 116”) that rotatably support the inner member 119 of the active spool 113, and a supply motor 118 (e.g., a geared DC motor) operably coupled to the active rollers 116 and configured to rotate them in place. As shown in FIG. 2C, the supply device 110 further includes a set of passive rollers 115a, 115b (collectively “passive rollers 115”) that rotatably support the inner member 119 at the opposite end of the active film spool 113. Together, the active rollers 116, supply motor 118 and passive rollers 115 can provide roll drive assistance and/or guidance to aid in unwinding the thin film 112 from the active film spool 113 and/or queued film spools 114 (FIG. 1B), each of which can weigh upwards of 200 kilograms. In addition, as shown in FIG. 2B, the supply device 110 can further include one or more sensors, such as a position and/or speed sensor 117a and a roll radius sensor 117b (collectively “sensors 117”). In some embodiments, the supply device 110 can include other sensors, such as a weight sensor, to determine how much thin film 112 remains on a spool and predict when the spool will need to be replaced. Although not shown in FIGS. 2A-2C, the features explained herein for the active film spool 113 can be similarly applied to the queued film spools 114 (FIG. 1B).

As explained in further detail below with reference to the drive device 120, the guidance provided by the supply device 110 (e.g., by the active rollers 116, passive rollers 115, supply motor 118 and sensors 117) can assist or limit the rate at which the thin film 112 is pulled by the drive device 120. For example, the roll drive assistance of the supply device 110 can assist the drive device 120 in pulling the thin film 112 off the active spool 113 by rotating the active rollers 116 in a direction that complements the drive device 120. In addition to or in lieu of the foregoing, the roll drive assistance can limit the rate at which the drive device 120 pulls the thin film 112 by not rotating the active rollers 116, or rotating the active rollers 116 in a non-complementary direction to that of the drive device 120. In some embodiments, the supply device 110 can direct the controller 160 to decrease the current being sent to the drive device 120 to control the rate at which the thin film 112 is pulled.

Dispensing the thin film 112 from the spools can be controlled based on one or more different factors. For example, the thin film 112 can be dispensed based on a desired production rate, wherein particular currents provided to the supply motor 118 correspond to different production rates, and/or the thin film 112 can be dispensed to maintain a desired tension in the thin film 112. When dispensing the thin film 112 is controlled for film tension, the rotation of the active spool 113 can be controlled according to Equation 1:

$$i = \frac{{r}_{2}}{{K}_{m} * {r}_{r}} * ( J * α + β * ω - R * F ) \qquad ( Equation 1 )$$

wherein:
i=motor current [A]
r₂=drive roller radius [m]
rᵣ=roll inside radius [m]
Kₘ=motor torque constant [N·m/A]
I=lumped moment of inertia [kg·m²]
α=roll angular acceleration [rad/s²]
β=viscous friction coefficient [kg·m²]
ω=roll angular speed [rad/s]
R=roll radius [m]
F=film tension [N]

In such an embodiment, the current provided to the supply motor 118 can be controlled based on a desired film tension, F. It should be noted that in some embodiments, the supply motor 118 can be omitted. For example, the spools can be placed on two sets of passive rollers and rotation of the spool can be determined by the drive motor 122 (FIG. 1B).

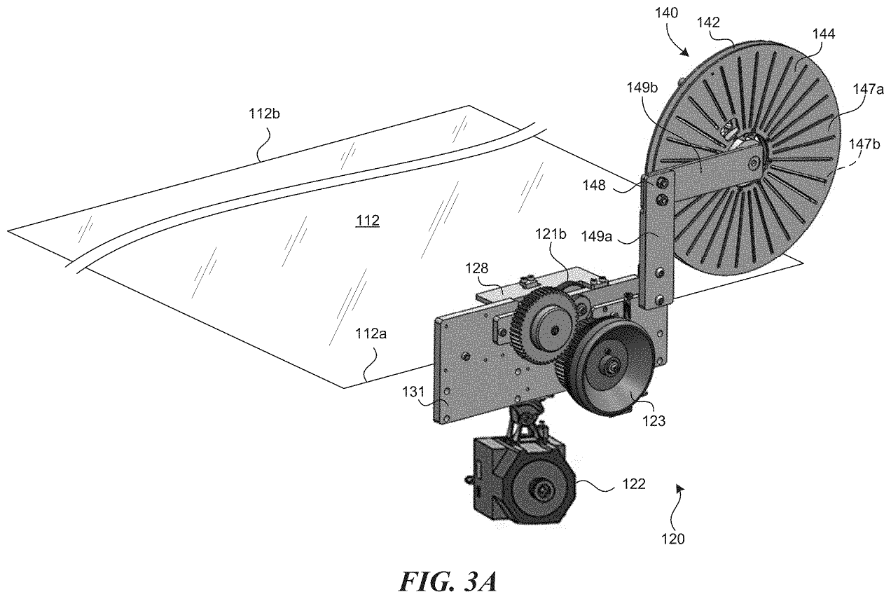

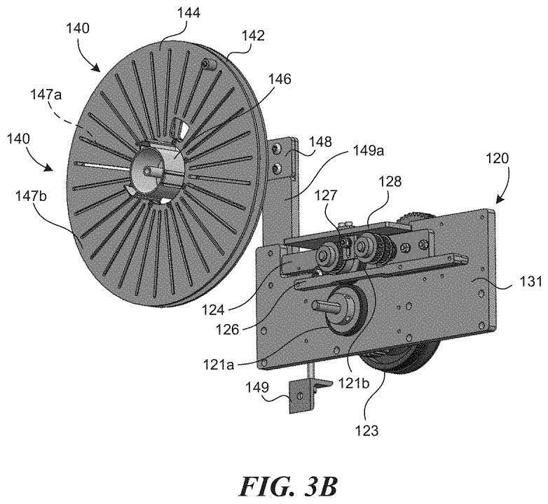

FIGS. 3A and 3B are partially schematic views of a representative drive device 120 and material application device 140, as also shown in FIG. 1B. Specifically, FIG. 3A is a view of a first side of the drive device 120 and material application device 140 (e,g., the side facing away from the thin film 112) and FIG. 3B is a view of a second side of the drive device 120 and material application device 140 (e.g., the side facing the thin film 112). Though FIGS. 3A and 3B are meant to illustrate the same drive device 120, some elements (e.g., the drive motor 122 and the thin film 112) are omitted from FIGS. 3A and 3B for illustrative purposes. Referring to FIGS. 3A and 3B together, the drive device 120 can include a drive motor 122 (FIG. 3A), a rotatable first drive wheel 121a (FIG. 3B) and a rotatable second drive wheel 121b (collectively “drive wheels 121”) operably coupled to the drive motor 122, e.g., via a series of gears and pulleys. The drive device 120 can further include a fixed cover 128 to cover the series of gears and pulleys, a plate 131, a clamp 149 to secure the drive device 120 to a structure (e.g., the structure 105 previously described with reference to FIG. 1B), and a material guide 126 secured to the plate 131 and used to support the thin film 112 as it is pulled through the drive device 120. In some embodiments, the interface formed between the plate 131 and material guide 126 can help ensure the edge portions 112a, 112b (FIG. 3A) of the thin film 112 are at least partially aligned with the drive wheels 121.

As shown in FIG. 3A, the drive motor 122 can turn a hand wheel 123, which turns the series of gears and pulleys, which ultimately turn the drive wheels 121. The drive motor 122 can be a servo motor or other rotary actuator, and can have speed control (e.g., speed limiting control). The drive wheels 121 can be fixed in place or can be biased in a particular direction. For example, as shown in FIG. 3B, the first drive wheel 121a is rotatably fixed to the plate 131, and the second drive wheel 121b is attached to a pivotable drive arm 124. The pivotable drive arm 124 can be secured to the plate 131 and be biased, e.g., via a spring 127 acting against the fixed cover 128. In some embodiments, the pivotable drive arm 124, and thus second drive wheel 121b, are biased in a direction toward the material guide 126 and/or the thin film 112 to apply pressure to the thin film 112 as it is pulled through the drive device 120. In some embodiments, the first drive wheel 121a can also be biased toward the material guide 126 to apply pressure to the thin film 112, but on the opposing surface of the thin film 112 opposite the surface contacted by the second wheel 121b.

In operation, the first drive wheel 121a and/or second drive wheel 121b provide a pulling force on the thin film 112 being supplied from the supply device 120. The pulling force is in a direction away from the supply device 110. As explained in more detail below with reference to the material application device 140, the drive wheels 121 can provide a pressure force on the edging material 142 that has been applied to the thin film 112, thereby securing the edging material 142 to the thin film 112.

As previously described with reference to FIG. 1B, the controller 160 (FIG. 1B) can set the production rate of the system 100 (FIG. 1B) by controlling the speed of the drive motor 122 (FIG. 3A). In some embodiments, the controller 160 can also limit the production rate of the system 100 based on whether, for example, film tension of the thin film 112 is maintained within a target range (e.g., about 2-5 kgf). For example, the sensors 117 (FIG. 2B) of the supply device 110 can calculate film tension on a real-time basis, which can be used by the controller 160 to limit the speed of the drive motor 122 accordingly.

FIGS. 3A and 3B also show the material application device 140, which can include a material arm 148 (e.g., a pivotable arm), a material holder 146 rotatably attached to the material arm 148, and a material spool 144 that includes the edging material 142 and is mounted on the material holder 146. The edging material 142 can include ethylene tetrafluoroethylene (ETFE), fluorinated ethylene propylene (FEP), polytetrafluoroethylene (PTFE), polyethylene (PE), polyethylene terephthalate (PET), polyimide (PA), polyvinylidene fluoride, polyvinylidene difluoride (PVDF), another suitable polymer, or a combination thereof. In some embodiments, the edging material 142 can also include metals, Kevlar™, metal-impregnated plastics, carbon fiber, glass fiber, or fabrics. The edging material 142 can also be color coded such that when the edging material 142 is applied to the thin film 112, different sections of the thin film 112 can be identified even when rolled in a spool. Additionally, the color coating can also indicate the orientation of the thin film 112 and the edging material 142. The material arm 148 includes a first vertical portion 149a fixed to the plate 131 of the drive device 120 via fasteners, and a horizontal portion 149b (FIG. 3A) attached to the vertical portion 149a. The material arm 148 can be arranged such that an inner surface (e.g., the surface facing the thin film 112, into the plane of FIG. 3A) of the horizontal portion 149b is co-planar with an inner surface (e.g., the surface facing the thin film 112, into the plane of FIG. 3A) of the plate 131. As such, the material spool 144 mounted to the material holder 146 can be at least partially aligned with the drive wheels 121 and/or the edge portions 112a, 112b of the thin film 112. The material holder 146 is rotatable about its central axis and thus rotates the material spool 144 mounted thereon. The material spool 144 can include a pair of disc-shaped outer plates 147a, 147b with the edging material 142 between the outer plates 147a, 147b. The edging material 142 is applied to the thin film 112 being pulled by the drive device 120, thereby causing the moving thin film 112 to draw the edging material 142 from the material spool 144, and causing the material spool 144 to rotate.

A benefit of some embodiments of the present technology and the arrangement of the material application device 140 is that a single motor (e.g., the drive motor 122) can control the supply device 110 (FIG. 1B), the drive device 120, the material application device 140, and the adhesive application device 150 (FIG. 1B). Stated another way, since the rotation of the material spool 144 and application of the edging material 142 to the thin film 112 can be synchronized with the rate at which the thin film 112 is being pulled by the drive wheels 121, the material application device 140 can be ultimately controlled by the drive motor 122.

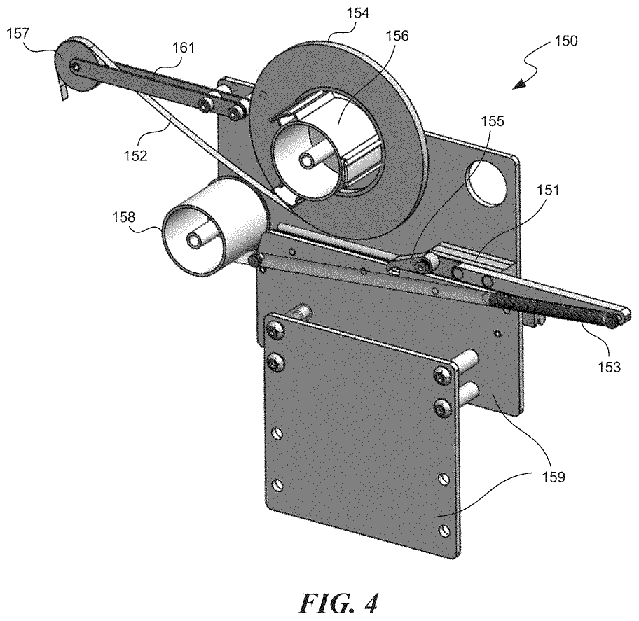

FIG. 4 is a partially schematic isometric view of a representative adhesive application device 150, also shown in FIG. 1B. The adhesive application device 150 can be positioned adjacent (e.g., upstream) of the material application device 140 (FIGS. 1B, 3A and 3B), and can include an adhesive holder 156 rotatable about a central axis, and an adhesive spool 154 mounted to the adhesive holder 156 and including the adhesive material 152. The adhesive application device 150 can further include a support piece 159 secured via fasteners to a structure (e.g., the structure 105 previously described with reference to FIG. 1B). The support piece 159 can be attached to the structure 105 (FIG. 1B) such that the adhesive spool 154 and/or adhesive applicator wheel 157 are at least partially aligned with the material spool 144 (FIGS. 3A and 3B) and the edge portions 112a, 112b of the thin film 112 (FIGS. 1B, 3A and 3B). The adhesive material 152 can include a single or double-sided tape (e.g., an industrial tape, acrylic adhesive, foam tape, etc.), or other adhesives on a carrier material (e.g., an elastic carrier). The adhesive application device 150 can further include an adhesive applicator wheel 157 for applying the adhesive material 152 to the edging material 142 (FIGS. 1B, 3A and 3B) on the material application device 140. The adhesive applicator wheel 157 can be rotatably attached to an applicator arm 161, which is attached to the support piece 159. In some embodiments, the adhesive material 152 and applicator wheel 157 can each have a width less than a width between inner surfaces of the outer plates 147a, 147b (FIGS. 3A and 3B) of the material spool 144 such that the applicator wheel 157 can fit between and be inserted at least partially beyond an outer surface of the outer plates 147a, 147b of the material spool 144 so that the adhesive material 152 can engage the edging material 142. The applicator arm 161 extends toward the drive device 120 (FIGS. 3A and 3B), and in some embodiments can be biased toward the material spool 144 (FIGS. 3A and 3B) of the drive device 120 such that the adhesive material 152 on the adhesive applicator wheel 157 is pressed against the edging material 142 on the material spool 144 (FIGS. 3A and 3B). As such, the adhesive applicator wheel 157 attached to the applicator arm 161 provides pressure (e.g., bonding pressure) on the edging material 142 to ensure the adhesive material 152 securely attaches to the edging material 142. The applicator arm 161, and thus the adhesive applicator wheel 157, can be biased toward the material spool 144 by a spring 153. Additionally, the adhesive applicator wheel 157 can be operably coupled to a linear actuator or bearing 151 which provides the biasing force from the spring 153 to the applicator wheel 157. The adhesive material 152 is disposed on a backside of the edging material 142 such that the adhesive material 152 is between the thin film 112 and the edging material 142 once the edging material 142 and adhesive material 152 are applied over the thin film 112. In operation, after the adhesive material 152 attaches to the edging material 142, the adhesive material 152 and edging material 142 are guided over one of the edge portions 112a or 112b of the thin film 112 (FIG. 1B) and squeezed by the drive wheels 121 (FIGS. 3A and 3B) to bond the edging material 142 to the thin film 112.

The adhesive application device 150 can further comprise other features to make the adhesive application device 150 more effective. For example, the adhesive application device 150 can include a remover device 158 that is positioned to remove a backing from the adhesive material 152 as the application wheel 157 and adhesive spool 154 rotate. For example, as the adhesive material 152 is applied to the edging material 142 (FIGS. 1B, 3A and 3B) via the adhesive applicator wheel 157, the backing of the adhesive material 152 (e.g., the double-sided tape) can separate from the adhesive material 152 and be taken up on the remover device 158. The remover device 158 can further include adjustable friction clutches, gears and pulleys to make the remover device more effective. The adhesive application device 150 can further include a pawl 155 to hold the adhesive application device 150 open while the adhesive spool 154 is swapped out.

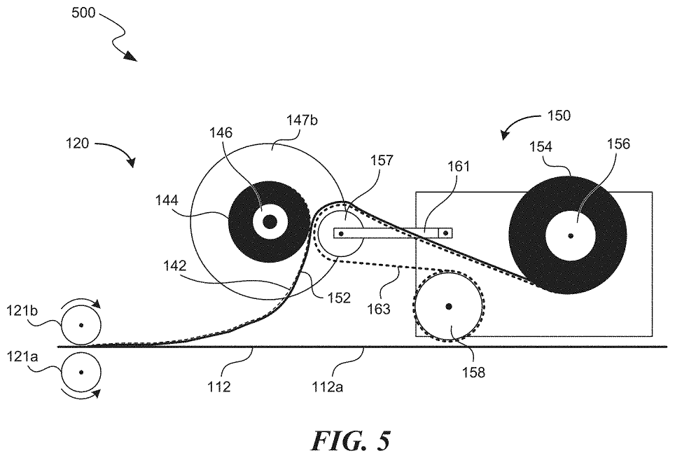

FIG. 5 is a partially schematic side view of a system (or subsystem) 500 configured to continuously apply the edging material 142 to an edge portion 112a of the thin film 112. The system 500 includes several features previously described with reference to FIGS. 1B-4, with certain features (e.g., the material arm 148, the plate 131 and the outer plate 147a of the drive device 120) omitted from FIG. 5 for illustrative purposes. As shown in FIG. 5, the drive device 120 includes the drive wheels 121a, 121b which are positioned on opposite sides of the thin film 112. Each of the drive wheels 121a, 121b are positioned to pull the thin film 112 in a direction away from the drive device 120 and adhesive applicator device 150 such that rotation of the drive wheels 121 causes the thin film 112 to move between and past the drive wheels 121. As the thin film 112 is pulled by the drive wheels 121, the edging material 142 can be continuously applied to the edge portion 112a of the thin film 112. More specifically, pulling the thin film 112 by the drive wheels 121 causes the edging material 142 to be pulled from the material spool 144, thereby causing the material holder 146 to rotate. Furthermore, as the edging material 142 is pulled from the material spool 144, the adhesive material 152 is pulled from the adhesive spool 154, thereby causing the adhesive holder 156 to rotate. As shown in FIG. 5, the adhesive material 152 is routed from the adhesive spool 154 to the applicator wheel 157. The applicator wheel 157 extends, via the applicator arm 161, beyond an outermost surface of the outer plate 147b of the material spool 144 such that the adhesive material 152 is applied directly to the edging material 142 on the material spool 144. As the adhesive material 152 is applied to the edging material 142, the backing 163 of the adhesive material 152 can be removed and/or gathered by the remover device 158, thereby exposing an adhesive surface of the adhesive material 152 to be applied directly to the thin film 112. In operation, the edging material 142 and the adhesive material 152 then pass through the drive wheels 121, which apply pressure to the edging material 142 and the adhesive material 152 to secure (e.g., bond) the edging material 142 to the edge portion 112a of the thin film 112. As such, the drive wheels 121 can provide a dual purpose of both pulling the thin film 112 through the system 500, as well as securing the edging material 142 to the edge portion 112a of the thin film 112.

An issue associated with the embodiments described with reference to FIG. 5 is that the width of the thin film can vary along a length of the thin film, which can cause difficulty in continuously applying the material to the edge portions of the thin film. To mitigate this issue, embodiments of the present disclosure can include an ability to move one or more individual components of the systems for applying the material to the edge portions, such that the systems can continuously apply the material to the edge portions.

FIG. 11 illustrates a partially schematic top view of portions of a system 1100 configured to apply an edging material 142 to edge portions 112a of a thin film 112, in accordance with some embodiments of the present technology. The system 1100 includes several features previously described with reference to FIGS. 1B-5, such as the active film spool 113 providing the thin film 112, the adhesive applicator device 150, and the material application device 140, with certain features (e.g., the drive device 120) omitted from FIG. 11 for illustrative purposes. As shown in FIG. 11, the system 1100 includes multiple pairs of edge wheels 1120a, 1120b, 1120c, 1120d (collectively “edge wheels 1120”), each of which includes a first wheel 1122a and a second wheel 1122b operably coupled to the first wheel 1122a, e.g., via a coupling member. Each of the edge wheels 1120 is configured to rotate the edge portion 112a of the thin film 112 in a given direction. For example, each of the edge wheels 1120 can be configured to rotate the edge portion 112a 90 degrees relative to the orientation of the thin film 112 entering the individual pair of edge wheels 1120a, 1120b, 1120c, 1120d. As shown in FIG. 11, the first pair of edge wheels 1120a is configured to cause a first rotation (R1) of 90 degrees of the edge portion 112a, the second pair of edge wheels 1120b is configured to cause a second rotation (R2) of another 90 degrees (i.e., 180 degrees total), the third pair of edge wheels 1120c is configured to cause a third rotation (R3) of another 90 degrees (i.e., 270 degrees total), and the fourth pair of edge wheels 1120d is configured to cause a fourth rotation (R4) of another 90 degrees (i.e., 360 degrees total). Accordingly, the combination of the edge wheels 1120 results in the edge portion 112a being folded upon itself. In some embodiments, the thin film 112 is creased by each pair of edge wheels 1120 as the thin film 112 passes therethrough. Creasing the thin film 112 can inhibit the rolled edge portion from unraveling and reverting to its unrolled orientation. A person of ordinary skill in the art will recognize that a different amount of edge wheels 1120 (e.g., three edge wheels or five edge wheels) could be included and configured to perform a similar function.

In some embodiments, the system 1100 can further include an elongate member 1110. As shown in FIG. 11, the member 1110 extends along a portion of the thin film 112 and is movable in a lateral direction (L) toward and/or away from the thin film 112. The member 1110 includes multiple arm portions 1112a, 1112b, 1112c, 1112d, 1112e, 1112f, 1112g (collectively “arm portions 1112”), extending toward the thin film 112 and coupled to individual components of the system 1100. For example, first arm portion 1112a is coupled to the adhesive applicator device 150, second arm portion 1112b is coupled to the material application device 140, third arm portion 1112c is coupled to the first pair of edge wheels 1120a, etc. The individual arm portions may be movable together or independent of one another. For example, the first arm portion 1112a can move a first distance and the second arm portion 1112b can move the same first distance, or a second distance different than the first distance.

In some embodiments, the system 1100 can further include an edge position sensor 1115. As shown in FIG. 11, the edge position sensor 1115 is positioned over the edge portion 112a of the thin film 112, and can be optionally operably coupled to the member 1110. In some embodiments, the edge position sensor 1115 can be configured to detect an outermost edge of the edge portion 112a and cause the arm portions 1112 to move in the lateral direction (L) such that the components of the system 1100 are aligned with the edge portion 112a and remain aligned with the edge portion 112a as the thin film 112 moves through the system 1100. In some embodiments, the edge position sensor 1115 can be operatively coupled directly to the member 1110 and the individual arm portions 1112, or operatively coupled indirectly to the member 1110 and the individual arm portions 1112, e.g., via the controller 160 (FIG. 1B).

In some embodiments, the system 1100 can further include a tension controller 1125. As shown in FIG. 11, the tension controller 1125 can be positioned downstream of the edge wheels 1120, and can be optionally coupled to the thin film 112 and member 1110. Generally speaking, the thin film 112 will have a tension within a predetermined range, with a tension too low (e.g., below the predetermined range) or too high (e.g., above the predetermined range) potentially causing issues with rolling the edge portion 112a (e.g., via the edge wheels 1120) and/or applying the edge material 142 to the edge portion, e.g., via the adhesive applicator device 150, and the material application device 140). Accordingly, the tension controller 1125 can be configured to detect the tension of the thin film 112, and adjust the member 1110 and the individual arm portions 1112 to relieve or add tension.

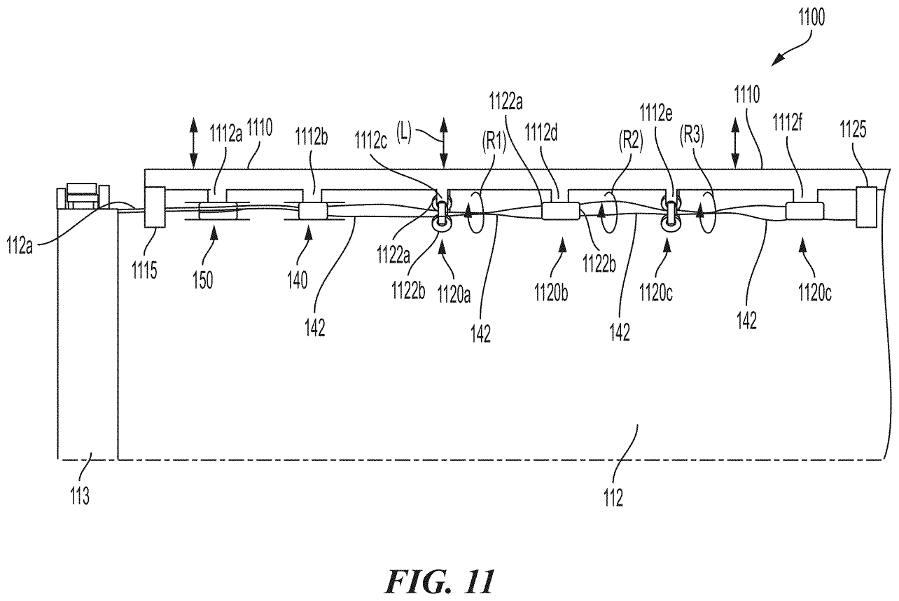

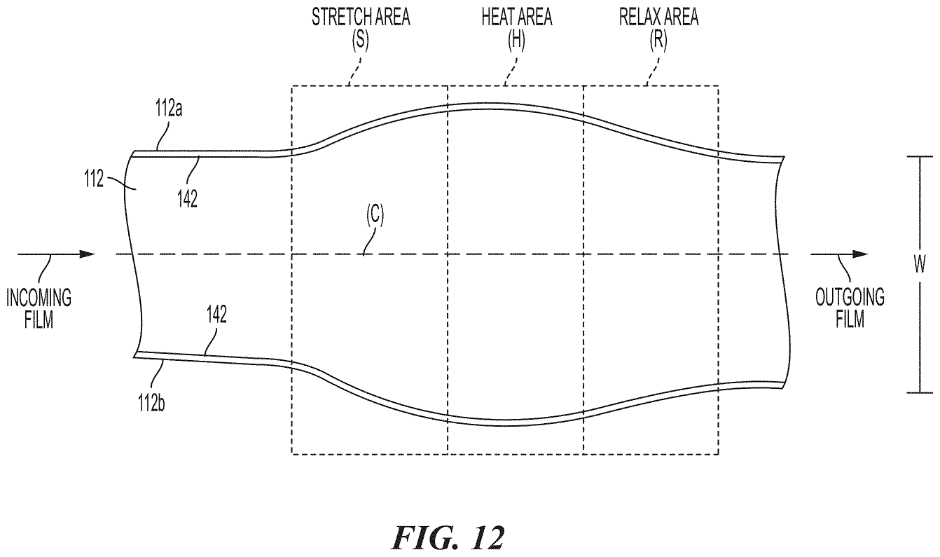

After applying the edge material 142 to the edge portion 112a of the thin film 112, the thin film 112 and edge portion 112a can be treated via stretching (e.g., in a lateral direction), heating, and relaxing. The present technology includes multiples systems and methods for performing such a function, as described in more detail below with reference to FIGS. 12-15.

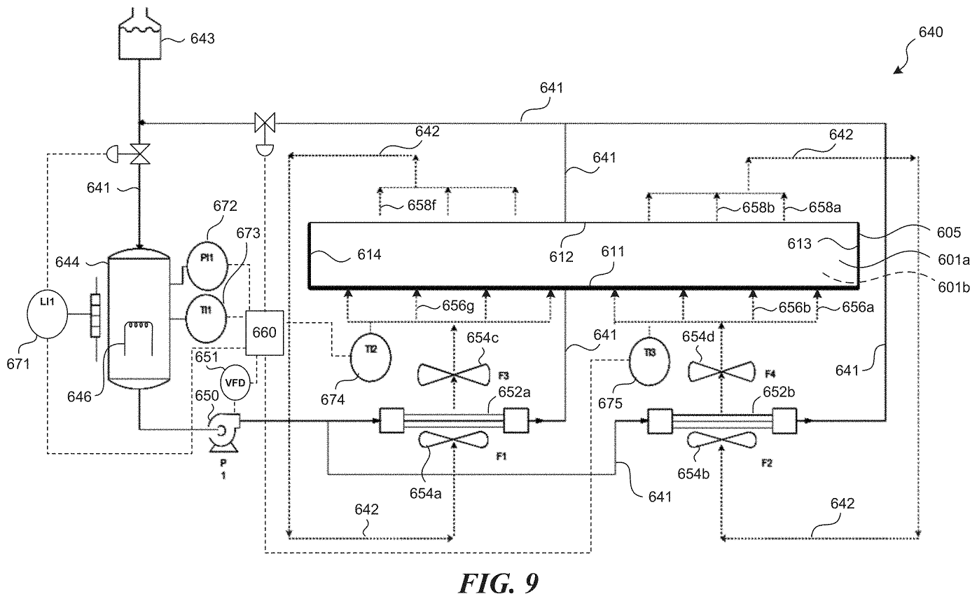

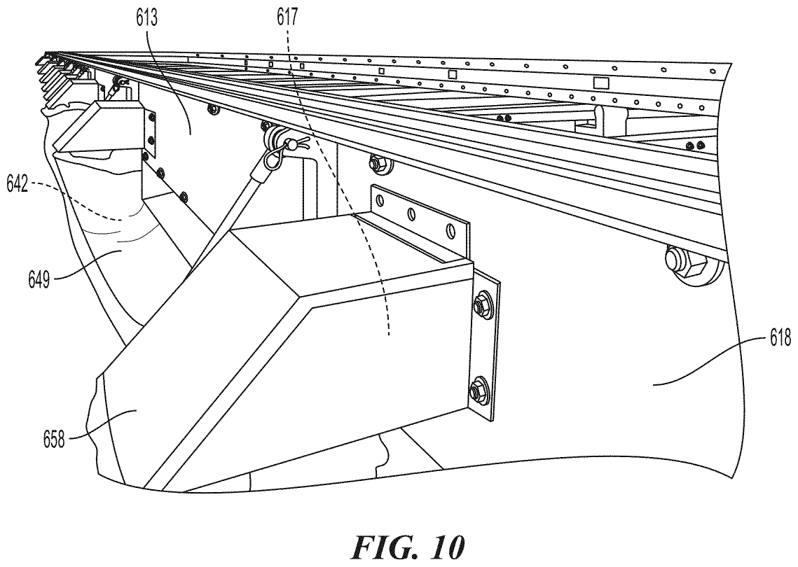

FIG. 12 illustrates a partially schematic top view of a treated thin film 112, in accordance with embodiments of the present technology. As shown in FIG. 12, the thin film 112 includes the first edge portion 112a, the second edge portion 112b opposite the first edge portion 112a, and edge materials 142 at each of the first edge portion 112a and second edge portion 112b. As also shown in FIG. 12, the thin film 112 includes (a) a stretch area (S) in which the thin film 112 is stretched in the lateral direction away from a centerline (C) of the thin film 112, (b) a heat area (H) downstream of the stretch area (S) in which the stretched portion of the thin film 112 is heated, and (c) a relax area (R) downstream of the heat area (H) in which the stretched and heated portion of the thin film 112 reverts back to a pre-stretched width. The heat area (H) can be heated using the systems and methods associated with the embodiments described with reference to FIGS. 9 and 10. In some embodiments, heat (e.g., heated air or fluid) can be applied via a heating mechanism to one (e.g., top or bottom) or both (e.g., top and bottom) sides of the thin film. For example, the heat area (H) can include a sealable chamber or enclosure at one or both sides of the thin film that is able to store and release heated air as desired, e.g., via slidable doors that open and close. In some embodiments, the heat applied to the thin film in the heat area (H) is released from the chamber prior to the thin film advancing toward the relax area (R). Releasing the heat from the heat area (H) prior to advancing the thin film can help prevent premature heat-shrinking. As described below, multiple embodiments of the present technology may be used to treat the thin film 112 in a manner that utilizes the stretch area (A), heat area (H), and/or relax area (R).

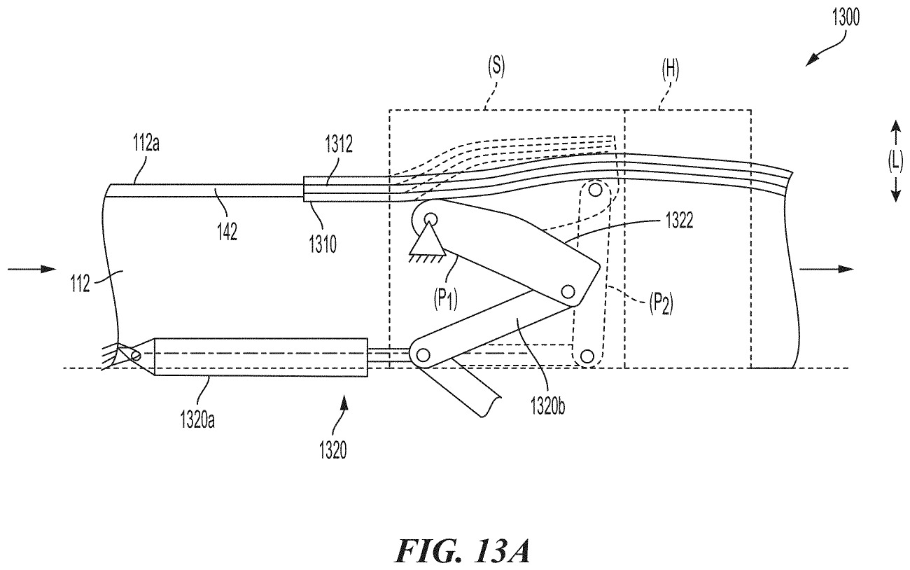

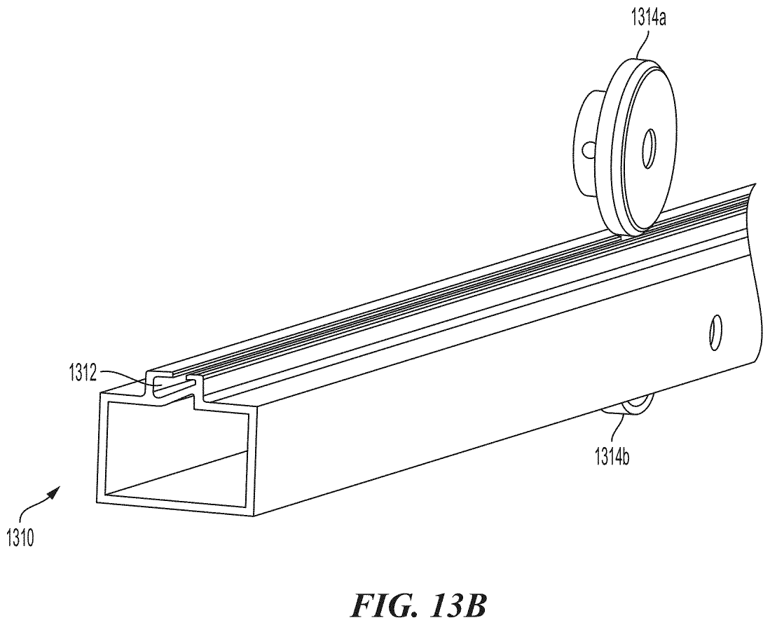

FIG. 13A illustrates a partially schematic view of a system 1300 configured to treat a thin film 112, in accordance with embodiments of the present technology. For illustrative purposes, FIG. 13A shows only one half of the system 1300. The other half of the system 1300 will generally be identical to the half shown. As shown in FIG. 13A, the system 1300 includes a continuous beam 1310 configured to hold (e.g., secure) a portion of the thin film 112. FIG. 13B illustrates a partially schematic view of the beam 1310, in accordance with embodiments of the present technology. As shown in FIG. 13B, the beam 1310 includes a groove 1312 extending along a length of the beam 1310, and a pair of drive wheels 1314a, 1314b (collectively “drive wheel pair 1314”). The groove 1312 is configured to hold the thin film 112, and the drive wheel pair 1314 is configured to move the thin film 112 along the groove 1312 from one end of the beam 1310 to an opposite end, e.g., in a manner similar to that previously described with reference to the drive wheels 121 (FIG. 5). The beam 1310 is bendable in a lateral direction (L) (e.g., a direction normal to the length of the beam), and can be made from materials comprising aluminum (e.g., extruded aluminum), titanium, carbon fiber, steel, or combinations thereof.

Referring again to FIG. 13A, the system 1300 can also include an actuator 1320. The actuator 1320 is configured to move a portion of the beam 1310 in the lateral direction (L) and thereby stretch the thin film 112. As shown in FIG. 13A, the actuator 1320 includes a first actuator portion 1320a and a second actuator portion 1320b coupled to the first actuator portion 1320a. The actuator 1320 is movable from a first position (P₁) to a second position (P₂). In the second position (P₂), a surface 1322 of the second actuator portion 1320b urges the beam in the lateral direction (L) (i.e., outwardly, away from a centerline of the thin film 112) until the thin film 112 is stretched to have a predetermined width. A person of ordinary skill in the art will recognize that while only a single embodiment of the system 1300 has been shown and described, variations to the system 1300 can exist that are in accordance with the present technology and that will accomplish a similar outcome. For example, the actuator 1320 may obtain a different shape, not include the first and second actuator portions 1320a, 1320b, or extend into the heat area (H).

In operation, the edge portions 112a of the thin film 112 are inserted into the groove 1312 of the beam 1310, and the beam is then moved in the lateral direction (L) to stretch the thin film 112 via the actuator 1320. The stretched thin film 112 is heated via the heat zone (H), and subsequently the tension of the stretched thin film 112 is released and the thin film 112 is allowed to relax and proceed, e.g., to further processing. This general process is repeated in an iterative manner to treat individual sections of the thin film 112 until an entire thin film 112 is treated.

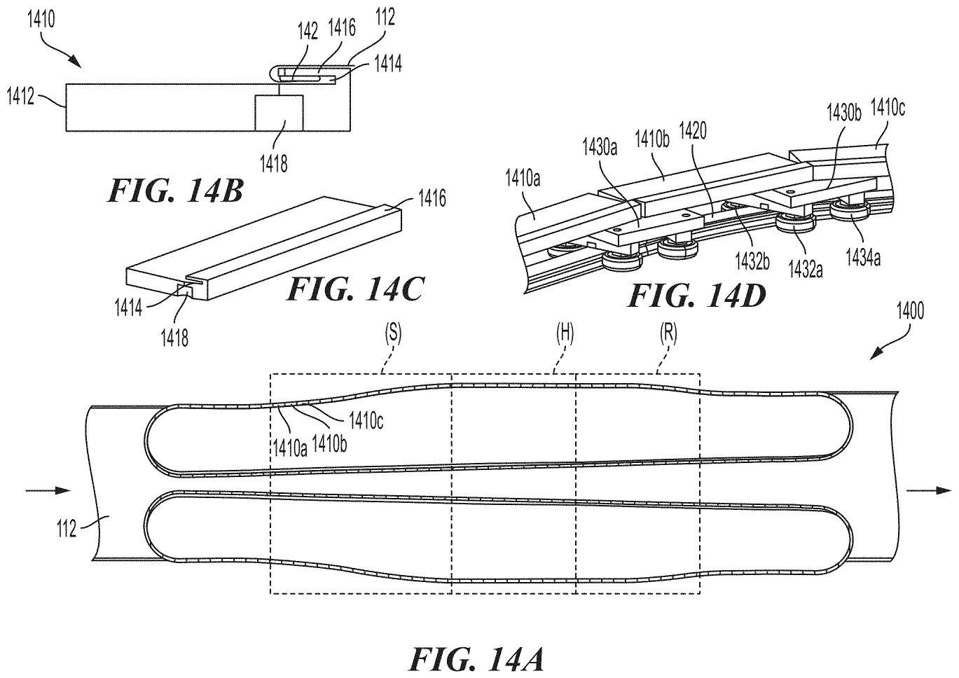

FIGS. 14A-14D illustrate partially schematic views of another system 1400 configured to treat the thin film 112, in accordance with some embodiments of the present technology. Generally speaking, the system 1400 provides means to treat a thin film 112 using a plurality of discrete carriers operably coupled to one another and configured to stretch individual portions of the thin film 112. As shown in FIG. 14A, the system 1400 includes multiple carriers 1410, including a first carrier 1410a, a second carrier 1410b coupled to the first carrier 1410a, and a third carrier 1410c coupled to the second carrier 1410b. Each of the carriers 1410 is movably (e.g., slidably) coupled to a continuous track that defines a path along which the carriers 1410 move. The path includes a portion within the stretch area (S), a portion within the heat area (H), and a portion within the relax area (R), as previously described. As shown in FIG. 14A, the multiple carriers 1410 together form a continuous arrangement.

FIG. 14B illustrates a side view of one of the carriers 1410, and FIG. 14C illustrates an isometric view of the carrier 1410 shown in FIG. 14B. Referring to FIGS. 14B and 14C together, the individual carrier 1410 includes a recess or hole 1418 that receives an upright pin or other pivot member (not shown in FIG. 14B). The pivot member allows neighboring carriers 1410 to pivot relative to each other (as shown in FIG. 14D and described further below). As shown in FIG. 14B, a lip portion 1416 defines a groove 1414 that is configured to hold (e.g., secure) at least a portion of the edging material 142 of the thin film 112.

FIG. 14D illustrates an isometric view of a portion of the system 1400. As shown in FIG. 14D, the system 1400 includes the first, second and third carriers 1410a, 1410b, 1410c, a first coupling cart 1430a configured to couple the first and second carriers 1410a, 1410b to one another, a second coupling cart 1430b configured to couple the second and third carriers 1410b, 1410c to one another, and a rail 1420 (e.g., a track). The rail 1420 defines the path along which the first and second coupling carts 1430a, 1430b (collectively “coupling carts 1430”) are configured to move. As such, the carriers 1410 holding the thin film 112 move along the path defined by the rail 1420 and move the thin film 112, e.g., through the stretch area (S), the heat area (H), and the relax area (R). Each of the coupling carts 1430 includes one or more wheel(s) that interface with the rail 1420 and are configured to aid moving the coupling carts 1430, and thus the thin film 112, along the rail 1420. As shown in FIG. 14D, the coupling carts include a first pair of wheels 1432a, 1432b, and a second pair of wheels 1434a (only 1434a of the second pair of wheels is shown).

As previously described, the neighboring carriers 1410 are configured to rotate along an axis defined by the pivot members positioned between them. By rotating relative to one another, for example, when the carriers 1410 begin to move in a partially lateral direction, the carriers 1410 can limit or eliminate any sharp angle formation in the thin film 112.

After applying edging material to a thin film and treating the thin film via a combination of stretching and heating, as described with reference to FIGS. 12-14D, the treated thin film can be cut along a width of the thin film. In some embodiments, edging material is applied to the cut edge, and the edging material on the cut edge is then stretched and heated, in a manner similar to that previously described. In some embodiments, the edging material can be pretreated before being applied to the cut edge of the thin film.

### Treating Thin Films to Have Target Characteristics

The technology and embodiments described above for applying materials to edge portions of thin films can also be beneficial for the technology and embodiments described below with reference to FIGS. 6A-10. FIGS. 6A and 6B, for example, are partially schematic isometric views of a system 600 configured to treat a thin film (e.g., the thin film 112 previously described with reference to FIG. 1B). Referring first to FIG. 6A, the system 600 can include a fixed base 602 (e.g., a support frame), and an adjustable structure 610 on the fixed base 602. The adjustable structure 610 can include a first rail 611 and a second rail 612, each defining a length (L) of the structure 610, and a third rail 613 and a fourth rail 614 defining a width (W) of the structure 610. The rails 611-614 can be made from metals or materials with high strength and high strain to yield characteristics. In some embodiments, the rails 611-614 can be made from aluminum (e.g., 6061-T651 aluminum), steel (e.g., 4043 chromoly steel), titanium, or composite materials (e.g., carbon fiber, Kevlar™, or glass fiber epoxy matrices), or combinations thereof. The first and second rails 611, 612 can be parallel to one another and perpendicular to the third and fourth rails 613, 614. Each of the rails 611-614 can include one or more channels (e.g., grooves), such as an upper channel 615a, 615b, 615c, 615d and/or a lower channel 616a, 616b, 616c, 616d (collectively “channels 615, 616”) each of which can extend along at least a portion of the length (L) or width (W) of the respective rails 611-614. For example, in some embodiments (as shown in FIG. 6A), the channels 615, 616 extend along the entire length (L) of the first and second rails 611, 612, and along the entire width (W) of the third and fourth rails 613, 614. Each of the upper channels 615a, 615b, 615c, 615d can be aligned with one another, and each of the lower channels 616a-d can be aligned with one another. The first and/or second rails 611, 612 can further include a plurality of moveable sections 618a, 618a, 618b, 618c, 618d, 618e, 618f, 618g, 618h, 618i, 618j, 618k, 618l, 618m (collectively “sections 618”). Each of the sections 618 includes two end portions 619 and can include an opening 617. As described in further detail below, each opening 617 of the sections 618 can be operably coupled to a thermal system.

The system 600 can further include a plurality of section rails 604 attached to and extending outwardly from the fixed base 602. Each of the section rails 604 can be transverse to the first and second rails 611, 612, and aligned with end portions 619 of the sections 618. The system 600 can further include a plurality of actuator mechanisms or actuators 606 mechanically coupled to the sections 618, actuator motors 608 operably coupled to each actuator mechanism 606, and a controller 605 operably coupled to the actuator motors 608. The actuator mechanisms 606 can include general purpose linear servo-actuators having load capacities of about 7,000N. As a specific example, the actuator mechanisms 606 can include ND8 DC Linear Actuators manufactured by Nook Enterprises™. The actuator mechanisms 606 can include built-in potentiometers, or position sensors 609 can be included externally. The actuator motors 608 can include general purpose DC motors that have an output current of at least 15A. The actuator mechanisms 606 can be controlled via the controller 605 and on an individual basis or in concert with one or another. The controller 605 can include features generally similar to those of the controller 160, as previously described. The actuators 606 can be mechanically coupled to one or more of the rails 611-614 (e.g., the first and second rails 611, 612, the third and fourth rails 613, 614, or all of the rails 611-614). Accordingly, the actuators 606 can stretch the films in a uniaxial direction, a biaxial direction, a lateral direction, a bilateral direction or any combination thereof.

The system 600 can support a first film (not shown in FIG. 6A) and a second film (not shown in FIG. 6A) secured to two or more of the rails 611-614. For example, the first film can be secured to the upper channels 615a, 615b, 615c, 615d of the rails 611-614, and the second film can be secured to the lower channels 616a, 616b, 616c, 616d of the rails 611-614, with an enclosure volume 603 being formed between the first and second films. Once secured to the channels 615 and 616, the first and/or second film can be stretched to a desired dimension by moving one or more of the sections 618 of a rail (e.g., the first rail 611 or the third rail 613) in a direction away from an opposing rail (e.g., the second rail 612 or the fourth rail 614, respectively). As such, the system 600 can treat and condition films to have a desired stretch, tension, strength and/or durability. The first and second films described with reference to FIGS. 6A-10 can be the thin films 112 previously described with reference to FIGS. 1A-5.

Once the first and/or second films are stretched, the stretched films can be treated (e.g., via the passage of time, optionally, with heat) to “lock-in” the stretch. As such, the first and/or second films can maintain all or at least a fraction of the stretched dimensions and/or shape after the first and/or second films are detached from the structure 605. In some embodiments, “locking-in” a stretch can occur by heating the first and/or second films to a temperature of from about 50° C. to about 80° C. for about 30 minutes to about 2 minutes. Accordingly, the amount of time the film spends at an elevated temperature can be inversely correlated with the temperature. This overall approach allows initially undersized panels of film to be attached to a supporting structure (e.g., the fixed structures previously described with reference to FIG. 1A) without using stretching jigs during installation. In some embodiments, the thin film is stretched by about 15-20% to increase its width, and by about an additional 3% to provide post-installation tension. This is significantly greater than the 0.5% amount stretch typically used in the industry. The films may be stretched to increase width of the film, or to provide more or less post-installation tension. In addition to or in lieu of the above, the films can be heated during or before the stretching to reduce stress in the films and/or increase homogeneity of the films. Depending on the material of the film, in some embodiments, this heating during or before the stretching can be beneficial or required.

After installation, the first and/or second films can be unlocked, e.g., by heating the device again to an unlocking temperature, which may be a higher or lower temperature than the locking temperature, depending on the film material, thereby causing the first and/or second films to shrink back toward their original state (e.g., their state before the stretch), and increase tension.

FIG. 6B illustrates another view of the system 600 shown in FIG. 6A. For example, FIG. 6B shows an interior view of the first rail 611 including the upper channel 615a, the lower channel 616a, the opening 617, the moveable section 618m, and the end portion 619 of the moveable section 618m, FIG. 6B also shows the section rail 604 on the fixed base 602, the actuator 606, and the actuator motor 608. Additionally, as shown in FIG. 6B, the fourth rail 614 can include individual movable units 607 that include portions of the upper and lower channels 615d, 616d. The units 607 can be coupled to the fourth rail 614 without being fixed in place (e.g. so as to float along the upper and lower channels 615d, 615d), and can include pins that secure the units 607 to the film secured in the upper and/or lower channels 615d, 616d. As the first and/or second rails 611, 612 are moved outwardly from each other, the units 607 can move along with the film as the film is being stretched. The units 607 can help ensure that the tension added to a film during the stretching operation is more evenly distributed over the width of the film. Though not shown, units 607 can also be included on the first rail 611, the second rail 612, and/or the third rail 613,

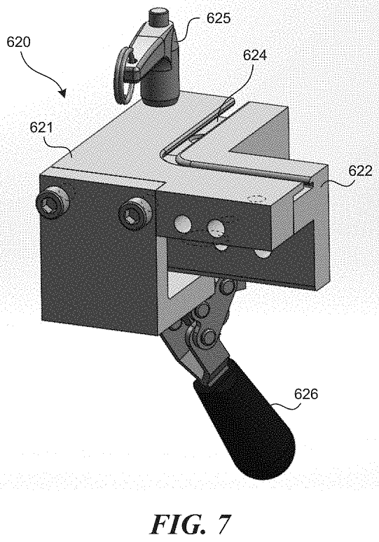

FIG. 6B also shows a corner mechanism 620 at an interface between the first rail 611 and the third rail 613. Details of the corner mechanism 620 are further illustrated in FIG. 7. As shown in FIG. 7, the corner mechanism 620 can include an outer corner portion 621, an inner corner portion 622 attached to the outer corner portion 621 (e.g., via fasteners), a corner channel 624 between the inner and outer corner portions 622, 621, and one or more pins 625 to secure the corner mechanism 620 to a thin film (e.g., the first and/or second films previously described with reference to FIG. 6A) secured to the corner channel 624. The corner mechanism 620 can further include a clamp 626 to secure the corner mechanism 620 in place (e.g., to a corresponding rail). The corner mechanism 620 can be useful for efficiently and effectively mounting and dismounting films from the system 100.

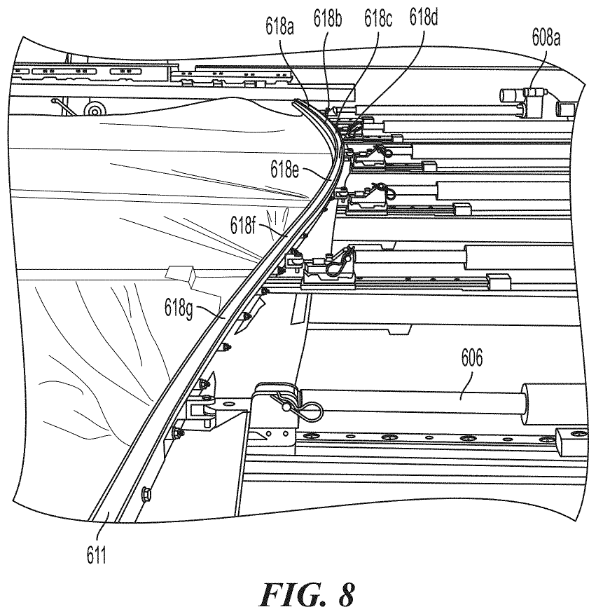

FIG. 8 illustrates a partially schematic view of some embodiments of the system 600 configured to treat a thin film. For example, FIG. 8 illustrates the moveable sections 618a-f of the first rail 611, wherein individual actuators 606 have actuated the sections 618a-f to produce a bend in the first rail 611. Accordingly, FIG. 8 illustrates that the actuators 606 can act individually to dynamically form various shapes of a thin film with particular stretch characteristics.

FIG. 9 is a block diagram of a thermal system 640 configured to generate and direct heated air to the structure 605 previously described with reference to FIG. 6A. As such, the thermal system 640 is configured to heat one or more thin films secured to and stretched by the structure 605. For example, heated air generated via the thermal system 640 can be directed into the enclosed volume 603 (FIG. 6A) between the first and second films, as described with reference to FIG. 6A. As shown schematically in FIG. 9, the structure 605 can include a first film 601a secured to upper channels (e.g., upper channels 615a, 615b, 615c, 615d previously described with reference to FIGS. 6A and 6B) of the rails 611-614, and a second film 601b positioned below the first film 601a and secured to lower channels (e.g., the lower channels 616a, 616b, 616c, 616d previously described with reference to FIGS. 6A and 6B) of the rails 611-614. The thermal system 640 can include a first closed loop comprising a first heated fluid stream 641 containing, e.g., water, and a second closed loop comprising a second heated fluid stream 642 containing, e.g., air. The second heated fluid stream 642 can be heated by the heated fluid stream 641 and used to heat the first and second films 601a, 601b. The second heated fluid stream 601b form an enclosure (e.g., the enclosure volume 603 previously described with reference to FIG. 6A, that the heated fluid stream 642 is directed into. 642 is in a closed loop because the first and second films 601a,

The first heated fluid stream 641 can include a water supply unit 643 and a thermal reservoir 644 that receives water from the water supply unit 643. The thermal reservoir 644 can include an electric heater 646 to heat the first heated fluid stream 641, and a plurality of sensors, such as a level sensor 671, a temperature sensor 672, and a pressure sensor 673. A heater pump 650 is positioned downstream of the thermal reservoir 644 to pump heated water of the first heated fluid stream 641 from the thermal reservoir 644 to one of more radiators 652a, 652b, where heat is transferred from the first heated fluid stream 641 to the second heated fluid stream 642. A variable frequency drive (VFD) 651 can be coupled to the heater pump 650 and can control the flow rate of the heater pump 650. The now-cooled first heated fluid stream 641 can be recycled from the radiators 652a, 652b back to the buffer vessel 644 to be reheated. While the first heated fluid stream 641 shown in FIG. 9 includes water as the heated and heating medium, other heating systems, such as a gas fired heater, can also be used.

The second heated fluid stream 642 can include a separate closed loop and can be heated by the first heated fluid stream 641. The second heated fluid stream 642 can include one or more fan units 654a, 654b, 654c, 654d that direct the second heated fluid stream 642 past the radiators 652a, 652b, thereby heating the second heated fluid stream 642 by convection. The second heated fluid stream 642 can then be directed to an inlet common header before entering the structure 605 via inlets 656a, 656b, 656c, 656d, 656e, 656f, 656g, 656h (e.g. inlet couplers) to heat the first and second films 601a, 601b. The temperature of the second heated fluid stream 642 can be measured at the inlet common header via one or more temperature sensors 674, 675. The second heated fluid stream 642 exits the structure 605 via outlets 658a, 658b, 658c, 658d, 658e, 658f (e.g. outlet couplers), and can be recycled back to the fan units 654a, 654b, 654c, 654d where the loop can be repeated. The second heated fluid stream 642 can include ducting or insulated piping to limit heat loss,

Inputs from the pressure, temperature, and fluid level sensors can be sent to a controller 660, which can regulate the electric heater 646, heater pump 650, and/or fans 654a, 654b, 654c, 654d to adjust the temperature of the second heated fluid stream 642. For example, to increase the temperature of the second heated fluid stream 642, the controller 660 can increase current being sent to the electric heater 646 and/or increase speed of the VFD coupled to the heater pump 650 to move more thermal energy toward the radiators 652a, 652b.

Thermal systems in accordance with embodiments of the present technology have a number of benefits over more conventional heating systems. For example, the closed loop setup of the first and second heated fluid streams 641, 642 can conserve energy within the system, thereby allowing the second heated fluid stream 642 to reach a target temperature relatively quickly (e.g., within five minutes). The target temperature can correspond to the “locking temperature,” as previously described with reference to FIG. 6A.

As previously described, in some embodiments, the system supports two films that enclose a common heated space (e.g., the enclosure volume 603 previously described with reference to FIG. 6A). In some embodiments, an insulating cavity may be included above and/or below the films to better maintain heat within the thermal system 640. In some embodiments, additional films can be included (e.g., stacked) over the first and second films. For example, the system can support a third film over the second film and that encloses a second common space between the second and third films. This second common heated space can be thermally controlled by, e.g., directing heating air from the thermal system. A person of ordinary skill in the relevant art will recognize that other arrangements with similar functionality is also supported by the system.

FIG. 10 illustrates a partial view of the thermal system 640 represented in FIG. 9. For example, FIG. 10 shows the third rail 613 and inlet couplers 658 attached to the openings (e.g., the openings 617 previously described with reference to FIG. 6A) of the sections 618 of the third rail 613. FIG. 10 also shows ducting 649 that can carry the second heated fluid stream 642.

From the foregoing, it will be appreciated that some embodiments of the present technology have been described herein for purposes of illustration, but that various modifications may be made without deviating from the technology. For example, with reference to FIGS. 1A-5, the supply device, drive device, material application device, and adhesive application device can be arranged in a different order to perform a similar function to that described herein. Similarly, with reference to FIGS. 6-10, the shapes, sizes, and features (e.g., number of moveable sections) of the technology described may vary while still maintaining the general functionality of the structure.

Some embodiments of thin film structures were discussed above in the context of collecting solar energy for energy conversion (e.g., to electricity and/or steam) and/or agricultural purposes (which can be considered as another specific form of energy conversion). In other embodiments, the collected solar energy can be used for other purposes, including dehydration and/or desalination. In still further embodiments, thin film structures having any one or combination of the characteristics described above can be used for applications other than collecting solar energy. For example, such structures can be used for stadiums and/or other large architectural buildings.

As used herein, the term “about” refers to the specific value, plus or minus 10%, unless specified otherwise. To the extent that any of the foregoing patents, published applications, and/or other materials incorporated herein by reference conflict with present disclosure, the present disclosure controls.

The subject technology is illustrated, for example, according to various aspects described below. Various examples of aspects of the subject technology are described as numbered examples (1, 2, 3, etc.) for convenience. These are provided as examples and do not limit the subject technology. It is noted that any of the dependent examples may be combined in any combination, and placed into a respective independent example, (e.g., examples 1, 15, 16, 23 or 40.). The other examples can be presented in a similar manner.

### EXAMPLES

1. A system configured to continuously apply an edging material to a film, the system comprising:
a supply device positioned to support a spool of film, the film having an edge portion;
a drive device positioned to pull the film, the drive device comprising a drive motor and a drive wheel operably coupled to the drive motor; and
a material application device positioned to apply an edging material to a portion of the film as the film is pulled via the drive device, the material application device comprising a material holder positioned to rotatably support a material spool carrying the edging material, wherein pulling the film causes the edging material to unspool from the material spool and be applied over the film.

2. The example of claim 1 wherein the drive wheel is positioned to apply pressure to the edge portion of the film and thereby secure the edging material to the film as the film is pulled past the drive wheel.

3. The example of claim 1 wherein the film includes a first surface and a second surface opposite the first surface, wherein the drive wheel includes a first drive wheel positioned over the first surface of the film and a second drive wheel positioned over the second surface of the film, and wherein rotation of the first and second drive wheels causes the film to be pulled past the first and second drive wheels.

4. The example of claim 1, further comprising an adhesive application device positioned to apply an adhesive material to the film as the film is pulled, the adhesive application device comprising a rotatable adhesive holder carrying the adhesive material, and wherein pulling the film causes the adhesive holder to rotate and the adhesive material to be applied to the film.

5. The example of claim 4 wherein the adhesive is a double-sided adhesive, the adhesive application device further comprising an adhesive applicator wheel positioned to apply the adhesive material directly to the edging material, wherein rotation of the adhesive applicator wheel is at least partially synchronized with the rotation of the adhesive holder.

6. The example of claim 1 wherein the edging material includes an adhesive that adheres to the film.

7. The example of claim 1 wherein the drive device is positioned to pull the film over a surface including a first end and a second end opposite the first end, wherein the edge portion is a first edge portion and the film has a second edge portion opposite the first edge portion, the drive device is a first drive device, the material application device is a first material application device, the edging material is a first edging material, and the material holder is a first material holder, and wherein the first edge portion, the first drive device and the first material application device are at the first end of the surface, the system further comprising:
a second drive device at the second end of the surface and operably coupled to the first drive device via a drive shaft extending from the first drive device to the second drive device; and
a second material application device at the second end of the surface and positioned to apply a second edging material to a moving portion of the film, the second material application device comprising a rotatable second material holder positioned to rotatably support a second material spool carrying the second edging material, and wherein pulling the film causes the second material holder to rotate and the second edging material to be applied over the film.

8. The example of claim 1, further comprising a controller operably coupled to the drive device, wherein the controller is configured to control the drive device based on at least one of production rate or film tension.

9. The example of claim 1 wherein the supply device includes a roller and a film spool on the roller, wherein the roller rotatably supports the film spool.

10. The example of claim 9 wherein the supply device further includes a roller motor operably coupled to the roller and configured to control rotation of the roller based at least in part on tension of the film.

11. The example of claim 1, further comprising an automated cutting system positioned downstream of the drive device and configured to cut the film.

12. The example of claim 1 wherein the film is composed of ethylene tetrafluoroethylene (ETFE), fluorinated ethylene propylene (FEP), polytetrafluoroethylene (PTFE), polyethylene (PE), polyethylene terephthalate (PET) or a combination thereof.

13. The example of claim 1, further comprising:
an edge position sensor configured to detect a position of the edge portion of the film; and
an elongate member in communication with the edge position sensor and coupled to at least one of the supply device or the material application device,
wherein the elongate member is configured to move at least one of the supply device or the material application device based on the detected position of the edge portion of the film.

14. The example of claim 1, further comprising one or more edge wheels configured to rotate the edge portion of the film relative to other portions of the film.

15. A system configured to continuously apply a stiffening material to a film edge, the system comprising:
a supply device positioned to support a spool of film, the film having an edge portion;
a drive device proximate to the supply device and positioned to pull the film from the spool in a first direction away from the supply device, the drive device comprising a drive motor and a drive wheel operably coupled to the drive motor, wherein the drive wheel is in contact with the film pulled from the spool, and wherein rotation of the drive wheels causes the film to move in the first direction;
a material application device positioned to apply a stiffening material to the edge portion of the film, the material application device comprising a rotatable material holder positioned to rotatably support a material spool carrying the stiffening material; and
an adhesive application device positioned to apply an adhesive material to the stiffening material, the adhesive application device comprising (a) a rotatable adhesive holder positioned to rotatably support an adhesive spool carrying the adhesive material, and (b) an adhesive applicator wheel operably coupled to the adhesive holder via the adhesive material, wherein the adhesive applicator wheel is positioned proximate the adhesive applicator and applies the adhesive material directly to the stiffening material when the film is pulled,
wherein—
   pulling the film causes (a) the material holder and the adhesive material holder to rotate and (b) the stiffening and adhesive materials to be simultaneously applied to edge portions of the film, and
   the drive wheels apply pressure to the stiffening and adhesive materials, thereby securing the stiffening material to the film.

16. A method for continuously applying an edging material to an outer portion of a film, the method comprising:
pulling a film via a drive wheel operably coupled to a drive motor;
applying an edging material from a material spool to an edge portion of the film while the film is pulled, wherein pulling the film causes the material spool to rotate and additional edging material to be applied to the edge portion; and
applying pressure to the film to bond the edging material to the film.

17. The example of claim 16 wherein pulling the film includes pulling the film over the drive wheel, and wherein applying pressure to the film includes applying pressure to the film via the drive wheel to bond the edging material to the edge portion of the film.

18. The example of claim 17 wherein the drive wheel includes two drive wheels positioned such that the film is pulled between the two drive wheels, and wherein at least one of the drive wheels is biased toward the film being pulled.

19. The example of claim 16 further comprising:
applying an adhesive material to the film via an adhesive application device, wherein the pulling of the film causes the adhesive material to be applied to the film.

20. The example of claim 19 wherein applying the adhesive material includes applying the adhesive material to the edging material prior to the application of the edging material to the film, and wherein applying pressure to the film includes applying pressure to the film to bond the edging material and adhesive to the film.

21. The example of claim 16 wherein the edge portion is a first edge portion, the edging material is a first edging material, and the material spool is a first material spool, the method further comprising:
applying a second edging material to a second edge portion of the film via a second material spool, wherein the second edge portion is opposite the first edge portion, and wherein the pulling of the film causes the second edging material to be applied to the second edge portion of the film.

22. The example of claim 16 wherein the film has a first width, the method further comprising:
after bonding the edging material to the film, securing the bonded edging material to a grooved portion of a structure;
stretching the secured film, in a direction away from a centerline of the film, from the first width to a second width greater than the first width; and
heating the stretched film to a temperature within a target range.

23. A system configured to treat one or more films, the system comprising:
a structure having a grooved portion configured to hold an edge portion of a film, wherein the structure is movable in an at least partially lateral direction away from a centerline of the film;
a thermal system positioned to apply heat to the film held by the structure; and
a controller operably coupled to the heating mechanism and configured to move the structure in the partially lateral direction.

24. The example of claim23, wherein the structure has a length and a width, and includes—
a first rail extending along at least part of the length of the structure;
a second rail generally opposite the first rail and extending along at least part of the length of the structure;
a third rail extending along at least part of the width of the structure; and
a fourth rail generally opposite the third rail and extending along at least part of the width of the structure,
   wherein each of the first, second, third, and fourth rails are positioned to secure the film having a first width;
the example further comprising one or more actuators operably coupled to the first rail,
wherein the controller is operably coupled to the actuators and configured to move at least a portion of the first rail, via the actuators, in a direction away from the second rail and thereby stretch the film from the first width to a second width larger than the first width.

25. The example of claim 24 wherein at least one of the first, second, third or fourth rails includes an opening, and wherein the thermal system is in fluid communication with the opening.

26. The example of claim 24 wherein each of the first, second, third, and fourth rails includes a channel to secure the film, wherein the film is a first film and the channels of the first, second, third, and fourth rails are upper channels, and wherein the first, second, third, and fourth rails each include a lower channel, the system further comprising:
a second film extending between the lower channels of the first, second, third, and fourth rails, wherein moving at least a portion of the first rail stretches the first and second films.

27. The example of claim 26 wherein at least one of the first, second, third or fourth rails includes an opening, the system further comprising a thermal system in fluid communication with the opening of the first rail, wherein the thermal system is positioned to direct heated air via the opening to an enclosure at least partially defined by the first film, second film, first rail, second rail, third rail, and fourth rail.

28. The example of claim 27 wherein the opening is a first opening, and wherein the system further comprises a second opening and ducting attached to the first and second openings.

29. The example of claim 27 wherein the temperature of the heated air is based on predetermined stretch characteristics of the film.

30. The example of claim 27 wherein the thermal system includes a heater pump, a variable frequency drive (VFD) operably coupled to the heater pump, and a heater controller operably coupled to the VFD, wherein the controller increases a speed of the VFD to increase temperature of the heated air.

31. The example of claim 24 wherein the first rail includes a plurality of moveable sections and the actuators are operably coupled to the moveable sections of the first rail, wherein each moveable section of the first rail includes an end portion, and wherein moving at least a portion of the first rail includes moving individual moveable sections by pulling the end portions of the individual sections via the actuators.

32. The example of claim 24 wherein the first rail comprises a metal material, a ceramic material, or combination of metal and ceramic materials.

33. The example of claim 23 wherein the structure is a continuous beam comprising the grooved portion, wherein the grooved portion extends along at least a portion of a length of the beam; wherein the beam is bendable in the lateral direction normal to the length of the beam and away from a centerline of the film; the system further comprising:
an actuator movable from a first position to a second position,
wherein—
   the film has more tension in the first position than in the second position, and
   the actuator is positioned relative to the beam such that movement of the actuator from the first position to the second position causes a portion of the beam to bend in the lateral direction.

34. The example of claim 33 wherein the controller is configured to move the beam via the actuator moving from the first position to the second position, and from the second position to the first position.

35. The example of claim 33, further comprising a pair of drive wheels coupled to opposing sides of the groove and configured to move the film along the length of the beam.

36. The example of claim 23 wherein the structure comprises a plurality of carriers, the system further comprising a continuous track,
wherein individual carriers are (a) coupled to adjacent carriers at opposing ends of the individual carrier, (b) movably coupled to the continuous track, (c) configured to secure a portion of a film, and
wherein movement of the carriers along the track within a section causes the tension of the film to increase in the lateral direction.

37. The example of claim 36 wherein the section is a first section and the tension is a first tension, and wherein movement of the carriers along the track within a second section, downstream of the first section, alters the tension of the film from the first tension to a second tension less than the first tension.

38. The example of claim 36, further comprising a plurality of carts, wherein the individual carriers are coupled to the adjacent carriers via individual carts.

39. The example of claim 38 wherein the individual carts comprise movable members contacting the track and configured to move the individual carts along the track.

40. A method for treating a thin film, the method comprising:
securing a film having a first width to a grooved portion of a structure;
stretching the secured film from the first width to a second width greater than the first width in a direction away from a centerline of the film; and
heating the stretched film to a target temperature.

41. The example of claim 40 wherein the structure is an adjustable structure, and wherein:
securing the film includes securing the film to first and second rails of the adjustable structure, wherein the second rail is positioned generally opposite the first rail,
stretching the secured film includes stretching the secured film by moving the first rail, via one or more actuators, in a direction away from the second rail.

42. The example of claim 41 wherein the first rail includes a plurality of sections, wherein each section is operably coupled to one of the actuators, and wherein moving the first rail includes moving the sections via the actuators.

43. The example of claim 42 wherein the sections include a first section and a second section adjacent the first section, and wherein the actuators include a first actuator operably coupled to the first section and a second actuator operably coupled to the second section, the method further comprising:
controlling the first actuator to move the first section to a first position; and
controlling the second actuator to move the second section to a second position different that the first position,
wherein movement of the first section to the first position and the second section to the second position results in the first rail having a bend.

44. The example of claim 41 wherein heating the stretched film includes heating the stretched film via a thermal system comprising a thermal reservoir, a heater pump, a variable frequency drive (VFD) operably coupled to the heater pump, and a heater controller operably coupled to the VFD.

45. The example of claim 41 wherein the film is a first film, wherein securing the film to first and second rails includes securing the film to first and second upper channels of the first and second rails respectively, the method further comprising:
securing a second film having the first width to first and second lower channels of the first and second rails respectively.

46. The example of claim 45 wherein heating the stretched film includes directing heated air to an enclosure area between the first and second films to heat the first and second films to a target temperature to maintain characteristics of the stretched films.

47. The example of claim 40 wherein the structure comprises a beam having a length, wherein:
stretching the secured film comprises bending a portion of the beam in the direction away from the centerline of the film, from a first position to a second position.

48. The example of claim 47, further comprising, after heating the portion of the film, enabling the bent portion of the film to revert back to the first position.

49. The example of claim 47 wherein bending the portion of the film includes bending the portion of the film via an actuator controlled by a controller.

I/we claim:

1. A system configured to continuously apply an edging material to a film, the system comprising:
a supply device positioned to support a spool of film, the film having an edge portion;
a drive device positioned to pull the film, the drive device comprising a drive motor and a drive wheel operably coupled to the drive motor; and
a material application device positioned to apply an edging material to a portion of the film as the film is pulled via the drive device, the material application device comprising a material holder positioned to rotatably support a material spool carrying the edging material, wherein pulling the film causes the edging material to unspool from the material spool and be applied over the film.

2. The system of claim 1 wherein the drive wheel is positioned to apply pressure to the edge portion of the film and thereby secure the edging material to the film as the film is pulled past the drive wheel.

3. The system of claim 1 wherein the film includes a first surface and a second surface opposite the first surface, wherein the drive wheel includes a first drive wheel positioned over the first surface of the film and a second drive wheel positioned over the second surface of the film, and wherein rotation of the first and second drive wheels causes the film to be pulled past the first and second drive wheels.

4. The system of claim 1, further comprising an adhesive application device positioned to apply an adhesive material to the film as the film is pulled, the adhesive application device comprising a rotatable adhesive holder carrying the adhesive material, and wherein pulling the film causes the adhesive holder to rotate and the adhesive material to be applied to the film.

5. The system of claim 4 wherein the adhesive is a double-sided adhesive, the adhesive application device further comprising an adhesive applicator wheel positioned to apply the adhesive material directly to the edging material, wherein rotation of the adhesive applicator wheel is at least partially synchronized with the rotation of the adhesive holder.

6. The system of claim 1 wherein the edging material includes an adhesive that adheres to the film.

7. The system of claim 1 wherein the drive device is positioned to pull the film over a surface including a first end and a second end opposite the first end, wherein the edge portion is a first edge portion and the film has a second edge portion opposite the first edge portion, the drive device is a first drive device, the material application device is a first material application device, the edging material is a first edging material, and the material holder is a first material holder, and wherein the first edge portion, the first drive device and the first material application device are at the first end of the surface, the system further comprising:
a second drive device at the second end of the surface and operably coupled to the first drive device via a drive shaft extending from the first drive device to the second drive device; and
a second material application device at the second end of the surface and positioned to apply a second edging material to a moving portion of the film, the second material application device comprising a rotatable second material holder positioned to rotatably support a second material spool carrying the second edging material, and wherein pulling the film causes the second material holder to rotate and the second edging material to be applied over the film.

8. The system of claim 1, further comprising a controller operably coupled to the drive device, wherein the controller is configured to control the drive device based on at least one of production rate or film tension.

9. The system of claim 1 wherein the supply device includes a roller and a film spool on the roller, wherein the roller rotatably supports the film spool.

10. The system of claim 9 wherein the supply device further includes a roller motor operably coupled to the roller and configured to control rotation of the roller based at least in part on tension of the film.

11. The system of claim 1, further comprising an automated cutting system positioned downstream of the drive device and configured to cut the film.

12. The system of claim 1 wherein the film is composed of ethylene tetrafluoroethylene (ETFE), fluorinated ethylene propylene (FEP), polytetrafluoroethylene (PTFE), polyethylene (PE), polyethylene terephthalate (PET) or a combination thereof.

13. The system of claim 1, further comprising:
an edge position sensor configured to detect a position of the edge portion of the film; and
an elongate member in communication with the edge position sensor and coupled to at least one of the supply device or the material application device,
wherein the elongate member is configured to move at least one of the supply device or the material application device based on the detected position of the edge portion of the film.

14. The system of claim 1, further comprising one or more edge wheels configured to rotate the edge portion of the film relative to other portions of the film.

15. A system configured to continuously apply a stiffening material to a film edge, the system comprising:
a supply device positioned to support a spool of film, the film having an edge portion;
a drive device proximate to the supply device and positioned to pull the film from the spool in a first direction away from the supply device, the drive device comprising a drive motor and a drive wheel operably coupled to the drive motor, wherein the drive wheel is in contact with the film pulled from the spool, and wherein rotation of the drive wheels causes the film to move in the first direction;
a material application device positioned to apply a stiffening material to the edge portion of the film, the material application device comprising a rotatable material holder positioned to rotatably support a material spool carrying the stiffening material; and
an adhesive application device positioned to apply an adhesive material to the stiffening material, the adhesive application device comprising (a) a rotatable adhesive holder positioned to rotatably support an adhesive spool carrying the adhesive material, and (b) an adhesive applicator wheel operably coupled to the adhesive holder via the adhesive material, wherein the adhesive applicator wheel is positioned proximate the adhesive applicator and applies the adhesive material directly to the stiffening material when the film is pulled,
wherein—
pulling the film causes (a) the material holder and the adhesive material holder to rotate and (b) the stiffening and adhesive materials to be simultaneously applied to edge portions of the film, and
the drive wheels apply pressure to the stiffening and adhesive materials, thereby securing the stiffening material to the film.

16. A method for continuously applying an edging material to an outer portion of a film, the method comprising:
pulling a film via a drive wheel operably coupled to a drive motor;
applying an edging material from a material spool to an edge portion of the film while the film is pulled, wherein pulling the film causes the material spool to rotate and additional edging material to be applied to the edge portion; and
applying pressure to the film to bond the edging material to the film.

17. The method of claim 16 wherein pulling the film includes pulling the film over the drive wheel, and wherein applying pressure to the film includes applying pressure to the film via the drive wheel to bond the edging material to the edge portion of the film.

18. The method of claim 17 wherein the drive wheel includes two drive wheels positioned such that the film is pulled between the two drive wheels, and wherein at least one of the drive wheels is biased toward the film being pulled.

19. The method of claim 16 further comprising:
applying an adhesive material to the film via an adhesive application device, wherein the pulling of the film causes the adhesive material to be applied to the film.

20. The method of claim 19 wherein applying the adhesive material includes applying the adhesive material to the edging material prior to the application of the edging material to the film, and wherein applying pressure to the film includes applying pressure to the film to bond the edging material and adhesive to the film.

21. The method of claim 16 wherein the edge portion is a first edge portion, the edging material is a first edging material, and the material spool is a first material spool, the method further comprising:
applying a second edging material to a second edge portion of the film via a second material spool, wherein the second edge portion is opposite the first edge portion, and wherein the pulling of the film causes the second edging material to be applied to the second edge portion of the film.

22. The method of claim 16 wherein the film has a first width, the method further comprising:
after bonding the edging material to the film, securing the bonded edging material to a grooved portion of a structure;
stretching the secured film, in a direction away from a centerline of the film, from the first width to a second width greater than the first width; and
heating the stretched film to a temperature within a target range.

23. A system configured to treat one or more films, the system comprising:
a structure having a grooved portion configured to hold an edge portion of a film, wherein the structure is movable in an at least partially lateral direction away from a centerline of the film;
a thermal system positioned to apply heat to the film held by the structure; and
a controller operably coupled to the heating mechanism and configured to move the structure in the partially lateral direction.

24. The system of claim 23, wherein the structure has a length and a width, and includes—
a first rail extending along at least part of the length of the structure;
a second rail generally opposite the first rail and extending along at least part of the length of the structure;
a third rail extending along at least part of the width of the structure; and
a fourth rail generally opposite the third rail and extending along at least part of the width of the structure,
wherein each of the first, second, third, and fourth rails are positioned to secure the film having a first width;
the system further comprising one or more actuators operably coupled to the first rail,
wherein the controller is operably coupled to the actuators and configured to move at least a portion of the first rail, via the actuators, in a direction away from the second rail and thereby stretch the film from the first width to a second width larger than the first width.

25. The system of claim 24 wherein at least one of the first, second, third or fourth rails includes an opening, and wherein the thermal system is in fluid communication with the opening.

26. The system of claim 24 wherein each of the first, second, third, and fourth rails includes a channel to secure the film, wherein the film is a first film and the channels of the first, second, third, and fourth rails are upper channels, and wherein the first, second, third, and fourth rails each include a lower channel, the system further comprising:
a second film extending between the lower channels of the first, second, third, and fourth rails, wherein moving at least a portion of the first rail stretches the first and second films.

27. The system of claim 26 wherein at least one of the first, second, third or fourth rails includes an opening, the system further comprising a thermal system in fluid communication with the opening of the first rail, wherein the thermal system is positioned to direct heated air via the opening to an enclosure at least partially defined by the first film, second film, first rail, second rail, third rail, and fourth rail.

28. The system of claim 27 wherein the opening is a first opening, and wherein the system further comprises a second opening and ducting attached to the first and second openings.

29. The system of claim 27 wherein the temperature of the heated air is based on predetermined stretch characteristics of the film.

30. The system of claim 27 wherein the thermal system includes a heater pump, a variable frequency drive (VFD) operably coupled to the heater pump, and a heater controller operably coupled to the VFD, wherein the controller increases a speed of the VFD to increase temperature of the heated air.

31. The system of claim 24 wherein the first rail includes a plurality of moveable sections and the actuators are operably coupled to the moveable sections of the first rail, wherein each moveable section of the first rail includes an end portion, and wherein moving at least a portion of the first rail includes moving individual moveable sections by pulling the end portions of the individual sections via the actuators.

32. The system of claim 24 wherein the first rail comprises a metal material, a ceramic material, or combination of metal and ceramic materials.

33. The system of claim 23 wherein the structure is a continuous beam comprising the grooved portion, wherein the grooved portion extends along at least a portion of a length of the beam; wherein the beam is bendable in the lateral direction normal to the length of the beam and away from a centerline of the film; the system further comprising:
an actuator movable from a first position to a second position,
wherein—
the film has more tension in the first position than in the second position, and
the actuator is positioned relative to the beam such that movement of the actuator from the first position to the second position causes a portion of the beam to bend in the lateral direction.

34. The system of claim 33 wherein the controller is configured to move the beam via the actuator moving from the first position to the second position, and from the second position to the first position.

35. The system of claim 33, further comprising a pair of drive wheels coupled to opposing sides of the groove and configured to move the film along the length of the beam.

36. The system of claim 23 wherein the structure comprises a plurality of carriers, the system further comprising a continuous track,
wherein individual carriers are (a) coupled to adjacent carriers at opposing ends of the individual carrier, (b) movably coupled to the continuous track, (c) configured to secure a portion of a film, and
wherein movement of the carriers along the track within a section causes the tension of the film to increase in the lateral direction.

37. The system of claim 36 wherein the section is a first section and the tension is a first tension, and wherein movement of the carriers along the track within a second section, downstream of the first section, alters the tension of the film from the first tension to a second tension less than the first tension.

38. The system of claim 36, further comprising a plurality of carts, wherein the individual carriers are coupled to the adjacent carriers via individual carts.

39. The system of claim 38 wherein the individual carts comprise movable members contacting the track and configured to move the individual carts along the track.

40. A method for treating a thin film, the method comprising:
securing a film having a first width to a grooved portion of a structure;
stretching the secured film from the first width to a second width greater than the first width in a direction away from a centerline of the film; and
heating the stretched film to a target temperature.

41. The method of claim 40 wherein the structure is an adjustable structure, and wherein:
securing the film includes securing the film to first and second rails of the adjustable structure, wherein the second rail is positioned generally opposite the first rail,
stretching the secured film includes stretching the secured film by moving the first rail, via one or more actuators, in a direction away from the second rail.

42. The method of claim 41 wherein the first rail includes a plurality of sections, wherein each section is operably coupled to one of the actuators, and wherein moving the first rail includes moving the sections via the actuators.

43. The method of claim 42 wherein the sections include a first section and a second section adjacent the first section, and wherein the actuators include a first actuator operably coupled to the first section and a second actuator operably coupled to the second section, the method further comprising:
controlling the first actuator to move the first section to a first position; and
controlling the second actuator to move the second section to a second position different that the first position,
wherein movement of the first section to the first position and the second section to the second position results in the first rail having a bend.

44. The method of claim 41 wherein heating the stretched film includes heating the stretched film via a thermal system comprising a thermal reservoir, a heater pump, a variable frequency drive (VFD) operably coupled to the heater pump, and a heater controller operably coupled to the VFD.

45. The method of claim 41 wherein the film is a first film, wherein securing the film to first and second rails includes securing the film to first and second upper channels of the first and second rails respectively, the method further comprising:
securing a second film having the first width to first and second lower channels of the first and second rails respectively.

46. The method of claim 45 wherein heating the stretched film includes directing heated air to an enclosure area between the first and second films to heat the first and second films to a target temperature to maintain characteristics of the stretched films.

47. The method of claim 40 wherein the structure comprises a beam having a length, wherein:
stretching the secured film comprises bending a portion of the beam in the direction away from the centerline of the film, from a first position to a second position.

48. The method of claim 47, further comprising, after heating the portion of the film, enabling the bent portion of the film to revert back to the first position.

49. The method of claim 47 wherein bending the portion of the film includes bending the portion of the film via an actuator controlled by a controller.
